(19) United States
(12) Patent Application Publication
(10) Pub. No.: US 2014/0273158 A1
(43) Pub. Date: Sep. 18, 2014

(54) Chromatography Membranes Stable Under Caustic Conditions

(71) Applicant: Natrix Separations Inc., Burlington (CA)

(72) Inventor: Amro Ragheb, Mississauga (CA)

(73) Assignee: Natrix Separations Inc., Burlington (CA)

(21) Appl. No.: 14/200,615

(22) Filed: Mar. 7, 2014

Related U.S. Application Data
(60) Provisional application No. 61/781,321, filed on Mar. 14, 2013.

(51) Int. Cl. B01J 20/291; B01D 15/42

(52) U.S. Cl. CPC B01J 20/291; B01D 15/42
USPC 435/206; 530/387.1; 210/656; 502/402; 502/4

(57) ABSTRACT

Disclosed are composite materials and methods of using them for chromatography. The composite materials retain their performance characteristics, such as binding capacity, flux, or percent recovery, under caustic conditions (e.g., 1 M NaOH for 24 h). In certain embodiments, the composite materials or membranes comprise a support member, comprising a plurality of pores extending through the support member; and a cross-linked gel. Importantly, the cross-linker and the monomer do not contain backbone ester linkages. The composite materials may be used in the separation or purification of a biological molecule or biological ion.

### RELATED APPLICATIONS

This application claims the benefit of priority to U.S. Provisional Patent Application Ser. No. 61/781,321, filed Mar. 14, 2013; the contents of which are hereby incorporated by reference.

### BACKGROUND OF THE INVENTION

Because the use of a caustic cleaning solution meets the cleaning/sanitization requirements for many pharmaceutical manufacturers and processors, an important feature of any separation or chromatographic media is compatibility with caustic solutions, such as those containing sodium hydroxide or other alkali metal hydroxides, or alkaline earth hydroxides. In addition, it is important for a separation or chromatography media to be useful under a wide range of operational conditions, including at basic pHs. Media that are useful under these conditions may be used to separate a range of target molecules that vary in their intrinsic properties, such as pI for different immunological biomolecules.

Unfortunately, many currently-available chromatography membranes are susceptible to degradation or irreversible alteration when exposed to basic solutions. Moreover, the extent (e.g., time and concentration) of exposure to base increasingly reduces their chromatographic performance. In particular, membranes made from polymers having ester linkages are susceptible to alkaline hydrolysis. It is known that acrylate monomers undergo hydrolysis under basic conditions, and it is reasonable to expect that polymers built from acrylate monomers are also subject to hydrolysis by basic solutions. This hydrolysis will alter both the structural integrity and the chemical nature of a membrane. A membrane that has been significantly hydrolyzed will exhibit altered binding capacity and permeability, as well as decreased purification capabilities.

There exists a need for separation or chromatography media and methods that display enhanced stability to basic conditions. These media must also display high selectivity and high flow velocity, display low back pressure, be inexpensive, and allow for long column-lifetimes, short process-times, and overall operational flexibility.

### BRIEF SUMMARY OF THE INVENTION

In certain embodiments, the invention relates to a composite material, comprising:

a support member, comprising a plurality of pores extending through the support member; and

a cross-linked gel, wherein the cross-linked gel comprises a polymer derived from a monomer and a cross-linker; the monomer does not comprise ester functionality; and the cross-linker does not comprise ester functionality;

wherein the cross-linked gel is located in the pores of the support member.

In certain embodiments, the invention relates to any one of the aforementioned composite materials, wherein the monomer is acrylic acid, acrylamide, N-acryloxysuccinimide, N,N-diethylacrylamide, N,N-dimethylacrylamide, N-[3-(N,N-dimethylamino)propyl]methacrylamide, N,N-dimethylacrylamide, methacrylamide, N-isopropylacrylamide, styrene, 4-vinylpyridine, vinylsulfonic acid, N-vinyl-2-pyrrolidinone (VP), acrylamido-2-methyl-1-propanesulfonic acid, N-(hydroxymethyl)acrylamide, N-(isobutoxymethyl)acrylamide, N-(hydroxyethyl)acrylamide, N-(3-Methoxypropyl)acrylamide, 2-acrylamidoglycolic acid, N-vinylformamide, N-[tris(hydroxymethyl)methyl]acrylamide, 3-acryloylamino-1-propanol, styrenesulfonic acid, (3-acrylamidopropyl)trimethylammonium halide, diallyldimethylammonium halide, 4-vinyl-N-methylpyridinium halide, vinylbenzyl-N-trimethylammonium halide, omethacryloxyethyltrimethylammonium halide, N-acrylamido polyethylenimine, N-methacrylamido polyethylenimine, N-acrylamido 4-arm amine-terminated poly(ethylene oxide), N-methacrylamido 4-arm amine-terminated poly(ethylene oxide), N-acrylamido trimethylolpropane tris[poly(propylene glycol)amine-terminated]ether, N-methacrylamido trimethylolpropane tris[poly(propylene glycol)amine-terminated]ether, N-acrylamido amine-terminate poly(N-isopropylacrylamide), N-methacrylamido amine-terminate poly(N-isopropylacrylamide), N-acrylamido poly-L-arginine hydrochloride, N-methacrylamido poly-L-arginine hydrochloride, N-acrylamido poly(ethylene glycol) bis(amine), N-methacrylamido poly(ethylene glycol) bis(amine), N-acrylamido poly(allylamine hydrochloride), N-methacrylamido poly(allylamine hydrochloride), N-acrylamido poly(dimethylamine-co-epichlorohydrin-co-ethylene diamine), N-methacrylamido poly(dimethylamine-co-epichlorohydrin-co-ethylenediamine), or diacetone acrylamide.

In certain embodiments, the invention relates to a method, comprising the step of:
contacting at a first flow rate a first fluid, comprising a substance, with any one of the aforementioned composite materials, thereby adsorbing or absorbing a portion of the substance onto the composite material.

In certain embodiments, the invention relates to a method, comprising the step of:
contacting at a first flow rate a first fluid, comprising a substance and an unwanted material, with any one of the aforementioned composite materials, thereby adsorbing or absorbing a portion of the unwanted material onto the composite material.

### BRIEF DESCRIPTION OF THE FIGURES

FIG. 1 depicts an environmental scanning electron microscopy (ESEM) image of S membrane formula A1-1.

FIG. 2 depicts an ESEM image of S membrane formula A1-4.

FIG. 3 depicts an ESEM image of S membrane formula A2-3.

FIG. 4 depicts an ESEM image of S membrane formula A2-9.

FIG. 5 depicts an ESEM image of S membrane formula A3-2.

FIG. 6 depicts an ESEM image of S membrane formula A3-5.

FIG. 7 depicts an ESEM image of S membrane formula B2.

FIG. 8 depicts an ESEM image of S membrane formula B3.

FIG. 9 depicts an ESEM image of S membrane formula C1-3.

FIG. 10 depicts an ESEM image of S membrane formula C1-4.

FIG. 11 depicts an ESEM image of S membrane formula D1.

FIG. 12 depicts an ESEM image of S membrane formula D3.

FIG. 13 tabulates the results of an assessment of caustic stability for an S membrane made with an acrylate crosslinker.

FIG. 14 tabulates the results of an assessment of caustic stability for a C membrane (weak cation exchange) made with an acrylate crosslinker.

FIG. 15 tabulates the components and their wt % s in various membranes made from AMPS monomer and Bis crosslinker in solvent system A1.

FIG. 16 tabulates the results of an assessment of caustic stability for membranes made from AMPS monomer and Bis crosslinker. BC=binding capacity.

FIG. 17 tabulates the components and their wt % s in various membranes made from AMPS monomer and Bis crosslinker in solvent system A2.

FIG. 18 tabulates the results of an assessment of caustic stability for membranes made from AMPS monomer and Bis crosslinker. BC=binding capacity.

FIG. 19 tabulates the components and their wt % s in various membranes made from from AMPS monomer and Bis crosslinker in solvent system A3.

FIG. 20 tabulates the results of an assessment of caustic stability for membranes made from AMPS monomer and Bis crosslinker. BC=binding capacity.

FIG. 21 tabulates the components and their wt % s in various membranes made from AMPS monomer, Bis crosslinker, and additional acrylamide crosslinkers.

FIG. 22 tabulates the results of an assessment of caustic stability for membranes made from AMPS monomer Bis crosslinker, and additional acrylamide crosslinkers. BC=binding capacity.

FIG. 23 tabulates the components and their wt % s in various membranes made from AMPS monomer and TACHTA crosslinker.

FIG. 24 tabulates the results of an assessment of caustic stability for membranes made from AMPS monomer and TACHTA crosslinker. BC=binding capacity.

FIG. 25 tabulates the components and their wt % s in various membranes made from AMPS monomer and HMBis crosslinker.

FIG. 26 tabulates the results of an assessment of caustic stability for membranes made from AMPS monomer and HMBis crosslinker. BC=binding capacity.

FIG. 27 depicts the binding capacity and recovery of a membrane made with Bis crosslinker over 40 cycles of use. Each cycle involved exposing the membrane to a basic solution at the beginning of the bind/elute process.

FIG. 28 depicts the binding capacity and recovery of a membrane made with HMBis crosslinker over 40 cycles of use. Each cycle involved exposing the membrane to a basic solution at the beginning of the bind/elute process.

FIG. 29 tabulates the flux and binding capacity for a C membrane exposed to NaOH. *85 mM sodium acetate, pH 5.0.

FIG. 30 tabulates the components and their wt % s in various membranes made from AA monomer, NIBoMAA co-monomer and Bis crosslinker.

FIG. 31 tabulates the flux and binding capacity for the membranes described in FIG. 30 after exposure to NaOH.

FIG. 32 depicts an ESEM image of C membrane formula 1-A2.

FIG. 33 depicts an ESEM image of C membrane formula 1-A4.

FIG. 34 tabulates the components and their wt % s in various membranes made from AA monomer, NMoPAA co-monomer and Bis crosslinker.

FIG. 35 tabulates the flux and binding capacity for the membranes described in FIG. 34 after exposure to NaOH.

FIG. 36 depicts an ESEM image of C membrane formula 1-B6.

FIG. 37 depicts an ESEM image of C membrane formula 1-B8.

FIG. 38 tabulates the components and their wt % s in various membranes made from AA monomer, NIPAA co-monomer and Bis crosslinker.

FIG. 39 tabulates the flux and binding capacity for the membranes described in FIG. 38 after exposure to NaOH.

FIG. 40 depicts an ESEM image of C membrane formula 1-C4.

FIG. 41 depicts an ESEM image of C membrane formula 1-C7.

FIG. 42 tabulates the components and their wt % s in various membranes made from AA monomer, NIBoMAA and NHEAA co-monomer and Bis crosslinker.

FIG. 43 tabulates the flux and binding capacity for the membranes described in FIG. 42 after exposure to NaOH.

FIG. 44 depicts an ESEM image of C membrane formula 2-A1.

FIG. 45 depicts an ESEM image of C membrane formula 2-A4.

FIG. 46 tabulates the components and their wt % s in various membranes made from AA monomer, NIBoMAA and NNDMAA co-monomer and Bis crosslinker.

FIG. 47 tabulates the flux and binding capacity for the membranes described in FIG. 46 after exposure to NaOH.

FIG. 48 depicts an ESEM image of C membrane formula 2-B1.

FIG. 49 depicts an ESEM image of C membrane formula 2-B5.

FIG. 50 tabulates the components and their wt % s in various membranes made from AA monomer, NIPAA and NHEAA co-monomer and Bis crosslinker.

FIG. 51 tabulates the flux and binding capacity for the membranes described in FIG. 50 after exposure to NaOH.

FIG. 52 depicts an ESEM image of C membrane formula 2-C1.

FIG. 53 depicts an ESEM image of C membrane formula 2-C2.

FIG. 54 tabulates the components and their wt % s in various membranes made from AA monomer, NIBoMAA and NNDMAA co-monomer and Bis crosslinker.

FIG. 55 tabulates the flux and binding capacity for the membranes described in FIG. 54 after exposure to NaOH.

FIG. 56 depicts an ESEM image of C membrane formula 3-A1.

FIG. 57 depicts an ESEM image of C membrane formula 3-A2.

FIG. 58 tabulates the components and their wt % s of a membrane made from AA and AAGA monomers, NNDMAA co-monomer and Bis crosslinker.

FIG. 59 tabulates the flux and binding capacity for the membrane described in FIG. 58 after exposure to NaOH.

FIG. 60 tabulates the components and their wt % s of a membrane made from AA monomer, NMoPAA co-monomer and Bis crosslinker.

FIG. 61 tabulates the flux and binding capacity for the membranes described in FIG. 60 after exposure to NaOH.

FIG. 62 depicts the binding capacity at 10% breakthrough (top data points, left axis) and % recovery (bottom data points, right axis) of IgG capture for C membrane 1-B6 made with AA, NMoPAA, and Bis.

FIG. 63 depicts the binding capacity at 10% breakthrough (top data points, left axis) and % recovery (bottom data points, right axis) of IgG capture for C membrane 2-A4 made with AA, NIBoMAA, NHEAA, and Bis.

FIG. 64 tabulates the mean pore diameter, flux, and dynamic binding capacity at 10% breakthrough (DBC_{10% BT}) of certain composite materials of the invention.

### DETAILED DESCRIPTION OF THE INVENTION

### Overview

There is a growing demand for bio-separation processes that are clean and safe, especially when operated in multicycle mode. One of the most popular sanitization steps in biopharmaceutical production processes is the use of caustic solution (such as aqueous sodium hydroxide or other alkali metal hydroxide, or alkaline earth hydroxide) to sanitize the media between cycles. Additionally, caustic solution may be used as a stripping step to ensure total removal of adsorbed molecules form the media before starting the next separation cycle. Therefore, caustic stability of the separation media is essential. An improved material would be capable of withstanding harsh caustic conditions, while maintaining the necessary flexibility to operate under various separation conditions.

When a conventional S membrane (strong cation exchange membrane) made of 2-acrylamido-2-methyl-1-propanesulfonic acid (AMPS) monomer and trimethylolpropane triacrylate (TRIM-A) as crosslinker was soaked in 1 M sodium hydroxide solution for 24 hours the membrane permeability was completely lost (i.e., the water flux through the membrane dropped to zero). Similar deterioration in permeability was observed when a C membrane (weak cation exchange) having ester functionality was subjected to the same basic conditions, as shown in a permeability (flux) test. See Example 2.

New sulfone (S) functionalized media membranes were made according to different formulas that incorporated acrylamide and methacrylamide monomers and crosslinkers, instead of acrylate and methacrylate monomers and crosslinkers.

In certain embodiments, the invention relates to a composite material, comprising a macroporous cross-linked gel, wherein the macroporous cross-linked gel was made using 2-acrylamido-2-methyl-1-propanesulfonic acid (AMPS) as the S functionalized monomer, and N,N′-methylenebis(acrylamide) (Bis) as a crosslinker. In certain embodiments, the permeability or the binding capacity can be tuned by using a different solvent system to make the composite material. In certain embodiments, the permeability of the composite material or membrane remains unchanged despite prolonged exposure to caustic solution (e.g., exposure to 1 M NaOH for 24 h).

In certain embodiments, the invention relates to a composite material, comprising a macroporous cross-linked gel, wherein the macroporous cross-linked gel was made from 2-acrylamido-2-methyl-1-propanesulfonic acid (AMPS) as the S functionalized monomer, and N,N′-methylenebis(acrylamide) (Bis) as a crosslinker, and two additional co-monomers, namely N-(hydroxymethyl)acrylamide (NHMAA) and N-(isobutoxymethyl)acrylamide (NIBoMAA). Examination of the membranes again showed that they retained their permeability after exposure to the same basic conditions.

In certain embodiments, the invention relates to a composite material, comprising a macroporous cross-linked gel, wherein the macroporous cross-linked gel was made from 2-acrylamido-2-methyl-1-propanesulfonic acid (AMPS) as the S functionalized monomer and 1,3,5-triacryloylhexahydro-1,3,5-triazine (TACHTA) as a crosslinker. In certain embodiments, the invention relates to a composite material, comprising a macroporous cross-linked gel, wherein the macroporous cross-linked gel was made from 2-acrylamido-2-methyl-1-propanesulfonic acid (AMPS) as the S functionalized monomer and N,N′-hexamethylenebis(methacrylamide) as a crosslinker. Examining the membranes performance showed that the membranes maintained their permeability, despite exposure to base (1 M NaOH for 24 h).

In certain embodiments, the composite materials of the invention demonstrate caustic stability under ongoing operating conditions. Membranes were subjected to a multicycle run (40 cycles of bind/elute) that included a caustic exposure (using 0.5 M NaOH) step at the beginning of every cycle. Results showed that the membranes delivered consistent performance with clear resistance to caustic deterioration.

In certain embodiments, when examined using environmental scanning electron microscopy (ESEM), the composite materials showed a well-connected gel network that is incorporated within the substrate fibres.

In certain embodiments, the composite materials of the invention can be effectively used in both “bind-elute” and “flow-through” modes.

“Bind-elute mode” as it relates to invention herein, refers to an operational approach to chromatography in which the buffer conditions are established so that both a target protein and undesired contaminants bind to the chromatographic support or composite material. Fractionation of target protein from the other components is achieved subsequently by changing the conditions such that the target protein and contaminants are eluted separately. In certain embodiments, a multimodal cation-exchange membrane of the invention may be used in “bind-elute mode” featuring high dynamic binding capacities at high conductivity, high volume throughput and selectivity. In certain embodiments, the amount of the target protein in the eluent is reduced by about 50% to about 99%. In certain embodiments, the eluent is reduced in aggregates of the target protein by about 90%, about 91%, about 92%, about 93%, about 94%, about 95%, about 96%, about 97%, about 98%, or about 99%.

As it relates to the invention herein, the term “flow-through mode” refers to an operational approach to chromatography in which the buffer conditions are established so that the intact target protein flows through the membrane upon application while contaminants are selectively retained. In certain embodiments, a multimodal anion-exchange membrane of the invention may be used in “flow-through mode” in a post-protein A purification process to remove key contaminants, such as DNA, host cell proteins (HCP), leached protein A, undesirable aggregates, and viruses in a single step.

### Various Characteristics of Exemplary Composite Materials

Composition of the Gels

In certain embodiments, the gels may be formed through the reaction of one or more cross-linkable polymers with one or more cross-linkers. In certain embodiments, the cross-linked gels may be formed through the in situ reaction of one or more polymerizable monomers with one or more cross-linkers. In certain embodiments, a cross-linked gel having macropores of a suitable size is formed.

The gel can be selected to comprise specific monomers having specific functionality. Additional monomers may be reacted with these monomers to produce copolymer gels.

In certain embodiments, the properties of the composite materials may be tuned by adjusting the average pore diameter of the macroporous gel. The size of the macropores is generally dependent on the nature and concentration of the cross-linking agent, the nature of the solvent or solvents in which the gel is formed, the amount of any polymerization initiator or catalyst and, if present, the nature and concentration of porogen. In certain embodiments, the composite material may have a narrow pore-size distribution.

Porous Support Member

In some embodiments, the porous support member contains pores of average diameter between about 0.1 and about 50 μm.

In some embodiments, the porous support member has a volume porosity between about 40% and about 90%.

In certain embodiments, the porous support is flat.

In certain embodiments, the porous support is disk-shaped.

Many porous substrates or membranes can be used as the support member. In some embodiments, the porous support member is made of polymeric material. In certain embodiments, the support may be a polyolefin, which is available at low cost. In certain embodiments, the polyolefin may be poly(ethylene), poly(propylene), or poly(vinylidene difluoride). Extended polyolefin membranes made by thermally induced phase separation (TIPS), or non-solvent induced phase separation are mentioned. In certain embodiments, the support member may be made from natural polymers, such as cellulose or its derivatives. In certain embodiments, suitable supports include polyethersulfone membranes, poly(tetrafluoroethylene) membranes, nylon membranes, cellulose ester membranes, fiberglass, or filter papers.

In certain embodiments, the porous support is composed of woven or non-woven fibrous material, for example, a polyolefin, such as polypropylene. Such fibrous woven or non-woven support members can have pore sizes larger than the TIPS support members, in some instances up to about 75 μm. The larger pores in the support member permit formation of composite materials having larger macropores in the macroporous gel. Non-polymeric support members can also be used, such as ceramic-based supports. The porous support member can take various shapes and sizes.

In some embodiments, the support member is in the form of a membrane.

In some embodiments, the support member has a thickness from about 10 to about 2000 μm, from about 10 to about 1000 μm, or from about 10 to about 500 μm.

In other embodiments, multiple porous support units can be combined, for example, by stacking. In one embodiment, a stack of porous support membranes, for example, from 2 to 10 membranes, can be assembled before the gel is formed within the void of the porous support. In another embodiment, single support member units are used to form composite material membranes, which are then stacked before use.

Relationship Between Gel and Support Member

The gel may be anchored within the support member. The term “anchored” is intended to mean that the gel is held within the pores of the support member, but the term is not necessarily restricted to mean that the gel is chemically bound to the pores of the support member. The gel can be held by the physical constraint imposed upon it by enmeshing and intertwining with structural elements of the support member, without actually being chemically grafted to the support member, although in some embodiments, the gel may be grafted to the surface of the pores of the support member.

Because the macropores are present in the gel that occupies the pores of the support member, the macropores of the gel must be smaller than the pores of the support member. Consequently, the flow characteristics and separation characteristics of the composite material are dependent on the characteristics of the gel, but are largely independent of the characteristics of the porous support member, with the proviso that the size of the pores present in the support member is greater than the size of the macropores of the gel. The porosity of the composite material can be tailored by filling the support member with a gel whose porosity is partially or completely dictated by the nature and amounts of monomer or polymer, cross-linking agent, reaction solvent, and porogen, if used. Properties of the composite material are determined partially, if not entirely, by the properties of the gel. The net result is that the invention provides control over macropore-size, permeability and surface area of the composite materials.

The number of macropores in the composite material is not dictated by the number of pores in the support material. The number of macropores in the composite material can be much greater than the number of pores in the support member because the macropores are smaller than the pores in the support member. As mentioned above, the effect of the pore-size of the support material on the pore-size of the macroporous gel is generally negligible. An exception is found in those cases where the support member has a large difference in pore-size and pore-size distribution, and where a macroporous gel having very small pore-sizes and a narrow range in pore-size distribution is sought. In these cases, large variations in the pore-size distribution of the support member are weakly reflected in the pore-size distribution of the macroporous gel. In certain embodiments, a support member with a somewhat narrow pore-size range may be used in these situations.

In certain embodiments, the invention relates to any one of the aforementioned composite materials, wherein the composite materials are relatively non-toxic.

### Preparation of Composite Materials

In certain embodiments, the composite materials of the invention may be prepared by single-step methods. In certain embodiments, these methods may use water or other environmentally benign solvents as the reaction solvent. In certain embodiments, the methods may be rapid and, therefore, may lead to simple and/or rapid manufacturing processes. In certain embodiments, preparation of the composite materials may be inexpensive.

In certain embodiments, the composite materials of the invention may be prepared by mixing more than one monomer, one or more cross-linking agents, one or more initiators, and optionally one or more porogens, in one or more suitable solvents. In certain embodiments, the resulting mixture may be homogeneous. In certain embodiments, the mixture may be heterogeneous. In certain embodiments, the mixture may then be introduced into a suitable porous support, where a gel forming reaction may take place.

In certain embodiments, suitable solvents for the gel-forming reaction include 1,3-butanediol, di(propylene glycol) propyl ether, N,N-dimethylacetamide, di(propylene glycol) dimethyl ether, 1,2-propanediol, di(propylene glycol) methyl ether acetate (DPMA), water, dioxane, dimethylsulfoxide (DMSO), dimethylformamide (DMF), acetone, ethanol, N-methylpyrrolidone (NMP), tetrahydrofuran (THF), ethyl acetate, acetonitrile, N-methylacetamide, propanol, methanol, tri(ethylene glycol) dimethyl ether, tri(propylene glycol) butyl ether, tri(propylene glycol) propyl ether, or mixtures thereof. In certain embodiments, solvents that have a higher boiling point may be used, as these solvents reduce flammability and facilitate manufacture. In certain embodiments, solvents that have a low toxicity may be used, so they may be readily disposed of after use. An example of such a solvent is dipropyleneglycol monomethyl ether (DPM).

In certain embodiments, a porogen may be added to the reactant mixture, wherein porogens may be broadly described as pore-generating additives. In certain embodiments, the porogen may be selected from the group consisting of thermodynamically poor solvents and extractable polymers (e.g., poly(ethyleneglycol)), surfactants, and salts.

In some embodiments, components of the gel forming reaction react spontaneously at room temperature to form the gel. In other embodiments, the gel forming reaction must be initiated. In certain embodiments, the gel forming reaction may be initiated by any known method, for example, through thermal activation or UV radiation. In certain embodiments, the reaction may be initiated by UV radiation in the presence of a photoinitiator. In certain embodiments, the photoinitiator may be selected from the group consisting of 2-hydroxy-1-[4-2(hydroxyethoxy)phenyl]-2-methyl-1-propanone (Irgacure 2959), 2,2-dimethoxy-2-phenylacetophenone (DMPA), benzophenone, benzoin and benzoin ethers, such as benzoin ethyl ether and benzoin methyl ether, dialkoxyacetophenones, hydroxyalkylphenones, and α-hydroxymethyl benzoin sulfonic esters. Thermal activation may require the addition of a thermal initiator. In certain embodiments, the thermal initiator may be selected from the group consisting of 1,1′-azobis(cyclohexanecarbonitrile) (VAZO® catalyst 88), azobis(isobutyronitrile) (AIBN), potassium persulfate, ammonium persulfate, and benzoyl peroxide.

In certain embodiments, the gel-forming reaction may be initiated by UV radiation. In certain embodiments, a photoinitiator may be added to the reactants of the gel forming reaction, and the support member containing the mixture of monomer, cross-linking agent, and photoinitiator may be exposed to UV radiation at wavelengths from about 250 nm to about 400 nm for a period of a few seconds to a few hours. In certain embodiments, the support member containing the mixture of monomer, cross-linking agent, and photoinitiator may be exposed to UV radiation at about 350 nm for a period of a few seconds to a few hours. In certain embodiments, the support member containing the mixture of monomer, cross-linking agent, and photoinitiator may be exposed to UV radiation at about 350 nm for about 10 minutes. In certain embodiments, visible wavelength light may be used to initiate the polymerization. In certain embodiments, the support member must have a low absorbance at the wavelength used so that the energy may be transmitted through the support member.

In certain embodiments, the rate at which polymerization is carried out may have an effect on the size of the macropores obtained in the macroporous gel. In certain embodiments, when the concentration of cross-linker in a gel is increased to sufficient concentration, the constituents of the gel begin to aggregate to produce regions of high polymer density and regions with little or no polymer, which latter regions are referred to as “macropores” in the present specification. This mechanism is affected by the rate of polymerization. In certain embodiments, the polymerization may be carried out slowly, such as when a low light intensity in the photopolymerization is used. In this instance, the aggregation of the gel constituents has more time to take place, which leads to larger pores in the gel. In certain embodiments, the polymerization may be carried out at a high rate, such as when a high intensity light source is used. In this instance, there may be less time available for aggregation and smaller pores are produced.

In certain embodiments, once the composite materials are prepared, they may be washed with various solvents to remove any unreacted components and any polymer or oligomers that are not anchored within the support. In certain embodiments, solvents suitable for the washing of the composite material include water, acetone, methanol, ethanol, propanol, and DMF.

### Exemplary Uses of the Composite Materials

In certain embodiments, the invention relates to a method, wherein a fluid is passed through the cross-linked gel of any one of the aforementioned composite materials. By tailoring the conditions for binding or fractionation, good selectivity can be obtained.

In certain embodiments, the invention relates to a method of separating biomolecules, such as proteins or immunoglobulins, from solution. In certain embodiments, the invention relates to a method of purifying biomolecules, such as proteins or immunoglobulins. In certain embodiments, the invention relates to a method of purifying proteins or monoclonal antibodies with high selectivity. In certain embodiments, the invention relates to a method, wherein the biological molecule or biological ion retains its tertiary or quaternary structure, which may be important in retaining biological activity. In certain embodiments, biological molecules or biological ions that may be separated or purified include proteins, such as albumins, e.g., bovine serum albumin, and lysozyme. In certain embodiments, biological molecules or biological ions that may be separated include γ-globulins of human and animal origins, immunoglobulins such as IgG, IgM, or IgE of human and animal origins, proteins of recombinant and natural origin including protein A, phytochrome, halophilic protease, poly(3-hydroxybutyrate) depolymerase, aculaecin-A acylase, polypeptides of synthetic and natural origin, interleukin-2 and its receptor, enzymes such as phosphatase, dehydrogenase, ribonuclease A, etc., monoclonal antibodies, fragments of antibodies, trypsin and its inhibitor, albumins of varying origins, e.g., α-lactalbumin, human serum albumin, chicken egg albumin, ovalbumin etc., cytochrome C, immunoglobulins, myoglobulin, recombinant human interleukin, recombinant fusion protein, nucleic acid derived products, DNA and RNA of synthetic and natural origin, DNA plasmids, lectin, α-chymotrypsinogen, and natural products including small molecules. In certain embodiments, the invention relates to a method of recovering an antibody fragment from variants, impurities, or contaminants associated therewith. In certain embodiments, biomolecule separation or purification may occur substantially in the cross-linked gel. In certain embodiments, biomolecule separation or purification may occur substantially in the macropores of the macroporous cross-linked gel.

In certain embodiments, the invention relates to a method of reversible adsorption of a substance. In certain embodiments, an adsorbed substance may be released by changing the liquid that flows through the gel. In certain embodiments, the uptake and release of substances may be controlled by variations in the composition of the cross-linked gel.

In certain embodiments, the invention relates to a method, wherein the substance may be applied to the composite material from a buffered solution.

In certain embodiments, the invention relates to a method, wherein the substance may be eluted using varying concentrations of aqueous salt solutions.

In certain embodiments, the invention relates to a method that exhibits high binding capacities. In certain embodiments, the invention relates to a method that exhibits binding capacities of about 10 mg/mL_{membrane}, about 20 mg/mL_{membrane}, about 30 mg/mL_{membrane}, about 40 Mg/mL_{membrane}, about 50 mg/mL_{membrane}, about 60 mg/mL_{membrane}, about 70 mg/mL_{membrane}, about 80 mg/mL_{membrane}, about 90 mg/mL_{membrane}, about 100 Mg/mL_{membrane}, about 110 Mg/mL_{membrane}, about 120 Mg/mL_{membrane}, about 130 Mg/mL_{membrane}, about 140 Mg/mL_{membrane}, about 150 Mg/mL_{membrane}, about 160 Mg/mL_{membrane}, about 170 Mg/mL_{membrane}, about 180 mg/mL_{membrane}, about 190 mg/mL_{membrane}, about 200 Mg/mL_{membrane}, about 210 Mg/mL_{membrane}, about 220 mg/mL_{membrane}, about 230 Mg/mL_{membrane}, about 240 Mg/mL_{membrane}, about 250 Mg/mL_{membrane}, about 260 Mg/mL_{membrane}, about 270 Mg/mL_{membrane}, about 280 mg/mL_{membrane}, about 290 Mg/mL_{membrane}, about 300 mg/mL_{membrane}, about 320 mg/mL_{membrane}, about 340 mg/mL_{membrane} mg/mL_{membrane}, about 360 mg/mL_{membrane}, about 380 mg/mL_{membrane}, or about 400 mg/mL_{membrane} at 10% breakthrough.

In certain embodiments, the flow rate during binding (the first flow rate) may be about 0.1 to about 10 mL/min. In certain embodiments, the flow rate during elution (the second flow rate) may be about 0.1 to about 10 mL/min. In certain embodiments, the first flow rate or the second flow rate may be about 0.1 mL/min, about 0.5 mL/min, about 1.0 mL/min, about 1.5 mL/min, about 2.0 mL/min, about 2.5 mL/min, about 3.0 mL/min, about 4.0 mL/min, about 4.5 mL/min, about 5.0 mL/min, about 5.5 mL/min, about 6.0 mL/min, about 6.5 mL/min, about 7.0 mL/min, about 7.5 mL/min, about 8.0 mL/min, about 8.5 mL/min, about 9.0 mL/min, about 9.5 mL/min, or about 10.0 mL/min. In certain embodiments, the first flow rate or the second flow rate may be about 0.5 mL/min to about 5.0 mL/min.

The water flux, Q_{H2O} (kg/m²h), was calculated using the following equation:

$${Q}_{{H}_{2} O} = \frac{( {m}_{1} - {m}_{2} )}{A \cdot t}$$

where m₁ is the mass of water transferred through the membrane at t₁, m₂ is the mass of water transferred through the membrane at t₂, A is the membrane cross-sectional area and t is the time (where t₁>t₂).

In certain embodiments, an additive may be added to the eluting salt solution (the second fluid, or the third or later fluid). In certain embodiments, the additive is added in a low concentration (e.g., less than about 2 M, about 1 M, about 0.5 M, or about 0.2 M). In certain embodiments, the additive is a water-miscible alcohol, a detergent, dimethyl sulfoxide, dimethyl formamide, or an aqueous solution of a chaotropic salt.

In certain embodiments, changing pH is an effective elution tool for protein elution without changing the conductivity of the mobile phase.

### Pore Size Determination

SEM and ESEM

The average diameter of the macropores in the macroporous cross-linked gel may be estimated by one of many methods. One method that may be employed is scanning electron microscopy (SEM). SEM is a well-established method for determining pore sizes and porosities in general, and for characterizing membranes in particular. Reference is made to the book Basic Principles of Membrane Technology by Marcel Mulder (© 1996) (“Mulder”), especially Chapter IV. Mulder provides an overview of methods for characterizing membranes. For porous membranes, the first method mentioned is electron microscopy. SEM is a very simple and useful technique for characterising microfiltration membranes. A clear and concise picture of the membrane can be obtained in terms of the top layer, cross-section and bottom layer. In addition, the porosity and pore size distribution can be estimated from the photographs.

Environmental SEM (ESEM) is a technique that allows for the non-destructive imaging of specimens that are wet, by allowing for a gaseous environment in the specimen chamber. The environmental secondary detector (ESD) requires a gas background to function and operates at from about 3 torr to about 20 torr. These pressure restraints limit the ability to vary humidity in the sample chamber. For example, at 10 torr, the relative humidity at a specific temperature is as follows:

| Relative Humidity at 10 torr (%) | T (° C.) |
|---|---|
| About 80 | About 16 |
| About 70 | About 18 |
| About 60 | About 20 |
| About 40 | About 24 |
| About 20 | About 40 |
| About 10 | About 50 |
| About 2 | About 70 |
| About 1 | About 100 |

This is a useful guide to relative humidity in the sample chamber at different temperatures. In certain embodiments, the relative humidity in the sample chamber during imaging is from about 1% to about 99%. In certain embodiments, the relative humidity in the sample chamber during imaging is about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%. In certain embodiments, the relative humidity in the sample chamber during imaging is about 45%

In certain embodiments, the microscope has nanometer resolution and up to about 100,000× magnification.

In certain embodiments, the temperature in the sample chamber during imaging is from about 1° C. to about 95° C. In certain embodiments, the temperature in the sample chamber during imaging is about 2° C., about 3° C., about 4° C., about 5° C., about 6° C., about 7° C., about 8° C., about 9° C., about 10° C., about 12° C., about 14° C., about 16° C., about 18° C., about 20° C., about 25° C., about 30° C., about 35° C., about 40° C., about 45° C., about 50° C., about 55° C., about 60° C., about 65° C., about 70° C., about 75° C., about 80° C., or about 85° C. In certain embodiments, the temperature in the sample chamber during imaging is about 5° C.

In certain embodiments, the pressure in the sample chamber during imaging is from about 0.5 torr to about 20 torr. In certain embodiments, the pressure in the sample chamber during imaging is about 4 torr, about 6 torr, about 8 torr, about 10 torr, about 12 torr, about 14 torr, about 16 torr, about 18 torr, or about 20 torr. In certain embodiments, the pressure in the sample chamber during imaging is about 3 torr.

In certain embodiments, the working distance from the source of the electron beam to the sample is from about 6 mm to about 15 mm. In certain embodiments, the working distance from the source of the electron beam to the sample is about 6 mm, about 7 mm, about 8 mm, about 9 mm, about 10 mm, about 11 mm, about 12 mm, about 13 mm, about 14 mm, or about 15 mm. In certain embodiments, the working distance from the source of the electron beam to the sample is about 10 mm.

In certain embodiments, the voltage is from about 1 kV to about 30 kV. In certain embodiments, the voltage is about 2 kV, about 4 kV, about 6 kV, about 8 kV, about 10 kV, about 12 kV, about 14 kV, about 16 kV, about 18 kV, about 20 kV, about 22 kV, about 24 kV, about 26 kV, about 28 kV, or about 30 kV. In certain embodiments, the voltage is about 20 kV.

In certain embodiments, the average pore diameter may be measured by estimating the pore diameters in a representative sample of images from the top or bottom of a composite material. One of ordinary skill in the art will recognize and acknowledge various experimental variables associated with obtaining an ESEM image of a wetted membrane, and will be able to design an experiment accordingly.

Capillary Flow Porometry

Capillary flow porometry is an analytical technique used to measure the pore size(s) of porous materials. In this analytical technique, a wetting liquid is used to fill the pores of a test sample and the pressure of a non-reacting gas is used to displace the liquid from the pores. The gas pressure and flow rate through the sample is accurately measured and the pore diameters are determined using the following equation: The gas pressure required to remove liquid from the pores is related to the size of the pore by the following equation:

D=4×γ×cos θ/P

D=pore diameter
γ=liquid surface tension
θ=liquid contact angle
P=differential gas pressure
This equation shows that the pressure required to displace liquid from the wetted sample is inversely related to the pore size. Since this technique involves the flow of a liquid from the pores of the test sample under pressure, it is useful for the characterization of “through pores” (interconnected pores that allow fluid flow from one side of the sample to the other). Other pore types (closed and blind pores) are not detectable by this method.

Capillary flow porometry detects the presence of a pore when gas starts flowing through that pore. This occurs only when the gas pressure is high enough to displace the liquid from the most constricted part of the pore. Therefore, the pore diameter calculated using this method is the diameter of the pore at the most constricted part and each pore is detected as a single pore of this constricted diameter. The largest pore diameter (called the bubble point) is determined by the lowest gas pressure needed to initiate flow through a wet sample and a mean pore diameter is calculated from the mean flow pressure. In addition, both the constricted pore diameter range and pore size distribution may be determined using this technique.

This method may be performed on small membrane samples (e.g., about 2.5 cm diameter) that are immersed in a test fluid (e.g., water, buffer, alcohol). The range of gas pressure applied can be selected from about 0 to about 500 psi.

Other Methods of Determining Pore Diameter

Mulder describes other methods of characterizing the average pore size of a porous membrane, including atomic force microscopy (AFM) (page 164), permeability calculations (page 169), gas adsorption-desorption (page 173), thermoporometry (page 176), permporometry (page 179), and liquid displacement (page 181). Mulder, and the references cited therein, are hereby incorporated by reference.

### Exemplary Composite Materials

In certain embodiments, the invention relates to a composite material, comprising:

a support member, comprising a plurality of pores extending through the support member; and

a cross-linked gel, wherein the cross-linked gel comprises a polymer derived from a monomer or monomers and a cross-linker; the monomer(s) does not comprise ester functionality; and the cross-linker does not comprise ester functionality;

wherein the cross-linked gel is located in the pores of the support member.

In certain embodiments, the invention relates to any one of the aforementioned composite materials, wherein the cross-linked gel is macroporous.

In certain embodiments, the invention relates to any one of the aforementioned composite materials, wherein the monomer comprises a carbonyl moiety. In certain embodiments, the invention relates to any one of the aforementioned composite materials, wherein the monomer comprises a carboxylate moiety.

In certain embodiments, the invention relates to any one of the aforementioned composite materials, wherein the monomer is acrylic acid, acrylamide, N-acryloxysuccinimide, N,N-diethylacrylamide, N,N-dimethylacrylamide, N-[3-(N,N-dimethylamino)propyl]methacrylamide, N,N-dimethylacrylamide, methacrylamide, N-isopropylacrylamide, styrene, 4-vinylpyridine, vinylsulfonic acid, N-vinyl-2-pyrrolidinone (VP), acrylamido-2-methyl-1-propanesulfonic acid, N-(hydroxymethyl)acrylamide, N-(isobutoxymethyl)acrylamide, N-(hydroxyethyl)acrylamide, N-(3-Methoxypropyl)acrylamide, 2-acrylamidoglycolic acid, N-vinylformamide, N-[tris(hydroxymethyl)methyl]acrylamide, 3-acryloylamino-1-propanol, styrenesulfonic acid, (3-acrylamidopropyl)trimethylammonium halide, diallyldimethylammonium halide, 4-vinyl-N-methylpyridinium halide, vinylbenzyl-N-trimethylammonium halide, omethacryloxyethyltrimethylammonium halide, N-acrylamido polyethylenimine, N-methacrylamido polyethylenimine, N-acrylamido 4-arm amine-terminated poly(ethylene oxide), N-methacrylamido 4-arm amine-terminated poly(ethylene oxide), N-acrylamido trimethylolpropane tris[poly(propylene glycol)amine-terminated]ether, N-methacrylamido trimethylolpropane tris[poly(propylene glycol)amine-terminated]ether, N-acrylamido amine-terminate poly(N-isopropylacrylamide), N-methacrylamido amine-terminate poly(N-isopropylacrylamide), N-acrylamido poly-L-arginine hydrochloride, N-methacrylamido poly-L-arginine hydrochloride, N-acrylamido poly(ethylene glycol) bis(amine), N-methacrylamido poly(ethylene glycol) bis(amine), N-acrylamido poly(allylamine hydrochloride), N-methacrylamido poly(allylamine hydrochloride), N-acrylamido poly(dimethylamine-co-epichlorohydrin-co-ethylenediamine), N-methacrylamido poly(dimethylamine-co-epichlorohydrin-co-ethylenediamine), or diacetone acrylamide.

In certain embodiments, the invention relates to any one of the aforementioned composite materials, wherein the monomer is derived from an amine-containing compound and acryloyl chloride, 3-ethoxyacryloyl chloride, 4-methoxycinnamoyl chloride, or 3-acryloyl-1,3-oxazolidin-2-one. In certain embodiments, the amine-containing compound is polyethylenimine, 4-arm amine-terminated poly(ethylene oxide), trimethylolpropane tris[poly(propylene glycol), amine terminated]ether, amine-terminate poly(N-isopropylacrylamide), poly-L-arginine hydrochloride, poly(ethylene glycol) bis(amine), poly(allylamine hydrochloride), or poly(dimethylamine-co-epichlorohydrin-co-ethylenediamine).

In certain embodiments, the invention relates to any one of the aforementioned composite materials, wherein the monomer is N,N-diethylacrylamide, N,N-dimethylacrylamide, N-isopropylacrylamide, acrylamido-2-methyl-1-propane sulfonic acid, N-(hydroxymethyl)acrylamide, N-(isobutoxymethyl)acrylamide, N-(hydroxyethyl)acrylamide, N-(3-Methoxypropyl)acrylamide, 2-acrylamidoglycolic acid, N-vinylformamide, N-[tris(hydroxymethyl)methyl]acrylamide, 3-acryloylamino-1-propanol, or diacetone acrylamide.

In certain embodiments, the invention relates to any one of the aforementioned composite materials, wherein the cross-linked gel comprises a polymer derived from more than one monomer and a cross-linker; and none of the monomers comprises ester functionality.

In certain embodiments, the invention relates to any one of the aforementioned composite materials, wherein the cross-linking agent is selected from the group consisting of bisacrylamidoacetic acid, 2,2-bis[4-(2-acryloxyethoxy)phenyl]propane, 2,2-bis(4-methacryloxyphenyl)propane, 1,4-butanediol divinyl ether, 1,4-diacryloylpiperazine, diallylphthalate, N,N-dodecamethylenebisacrylamide, divinylbenzene, glycerol tris(acryloxypropyl)ether, N,N′-hexamethylenebisacrylamide, triethylene glycol divinyl ether, diallyl diglycol carbonate, poly(ethylene glycol) divinyl ether, N,N′-dimethacryloylpiperazine, divinyl glycol, N,N′-methylenebisacrylamide, N,N′-ethylenebis(acrylamide), N,N′-(1,2-dihydroxyethylene)bis-acrylamide, N,N′-hexamethylenebis(methacrylamide), N,N′-octamethylenebisacrylamide, N,N′-dimethacryloylpiperazine, 1,3,5-triacryloylhexahydro-1,3,5-triazine, and divinylbenzene.

In certain embodiments, the invention relates to any one of the aforementioned composite materials, wherein the cross-linking agent is N,N′-methylenebisacrylamide, N,N′-hexamethylenebis(methacrylamide), 1,3,5-triacryloylhexahydro-1,3,5-triazine, or divinylbenzene.

In certain embodiments, the invention relates to any one of the aforementioned composite materials, wherein the cross-linked gel comprises a polymer derived from 2-acrylamido-2-methyl-1-propanesulfonic acid (AMPS) and N,N′-methylenebis(acrylamide). In certain embodiments, the invention relates to any one of the aforementioned methods, wherein the cross-linked gel comprises a polymer derived from 2-acrylamido-2-methyl-1-propanesulfonic acid (AMPS) and N,N′-methylenebis(acrylamide) in a weight ratio of about 20:about 1. In certain embodiments, the invention relates to any one of the aforementioned methods, wherein the cross-linked gel comprises a polymer derived from 2-acrylamido-2-methyl-1-propanesulfonic acid (AMPS) and N,N′-methylenebis(acrylamide) in a weight ratio of about 10:about 1.

In certain embodiments, the invention relates to any one of the aforementioned composite materials, wherein the cross-linked gel comprises a polymer derived from 2-acrylamido-2-methyl-1-propanesulfonic acid (AMPS), N,N′-methylenebis(acrylamide), N-(hydroxymethyl)acrylamide (NHMAA), and N-(isobutoxymethyl)acrylamide. In certain embodiments, the invention relates to any one of the aforementioned methods, wherein the cross-linked gel comprises a polymer derived from 2-acrylamido-2-methyl-1-propanesulfonic acid (AMPS), N,N′-methylenebis(acrylamide), N-(hydroxymethyl)acrylamide (NHMAA), and N-(isobutoxymethyl)acrylamide in a weight ratio of about 10:about 2:about 3:about 0. In certain embodiments, the invention relates to any one of the aforementioned methods, wherein the cross-linked gel comprises a polymer derived 2-acrylamido-2-methyl-1-propanesulfonic acid (AMPS), N,N′-methylenebis(acrylamide), N-(hydroxymethyl)acrylamide (NHMAA), and N-(isobutoxymethyl)acrylamide in a weight ratio of about 8:about 1:about 0:about 2. In certain embodiments, the invention relates to any one of the aforementioned methods, wherein the cross-linked gel comprises a polymer derived 2-acrylamido-2-methyl-1-propanesulfonic acid (AMPS), N,N′-methylenebis(acrylamide), N-(hydroxymethyl)acrylamide (NHMAA), and N-(isobutoxymethyl)acrylamide in a weight ratio of about 10:about 2:about 0:about 2.

In certain embodiments, the invention relates to any one of the aforementioned composite materials, wherein the cross-linked gel comprises a polymer derived from 2-acrylamido-2-methyl-1-propanesulfonic acid (AMPS) and 1,3,5-triacryloylhexahydro-1,3,5-triazine. In certain embodiments, the invention relates to any one of the aforementioned methods, wherein the cross-linked gel comprises a polymer derived from 2-acrylamido-2-methyl-1-propanesulfonic acid (AMPS) and 1,3,5-triacryloylhexahydro-1,3,5-triazine in a weight ratio of about 10:about 1.

In certain embodiments, the invention relates to any one of the aforementioned composite materials, wherein the cross-linked gel comprises a polymer derived from 2-acrylamido-2-methyl-1-propanesulfonic acid (AMPS) and N,N′-hexamethylenebis(methacrylamide). In certain embodiments, the invention relates to any one of the aforementioned methods, wherein the cross-linked gel comprises a polymer derived from 2-acrylamido-2-methyl-1-propanesulfonic acid (AMPS) and N,N′-hexamethylenebis(methacrylamide) in a weight ratio of about 10:about 1.

In certain embodiments, the invention relates to any one of the aforementioned composite materials wherein the cross-linked gel comprises macropores; and the macropores have an average pore diameter of about 10 nm to about 3000 nm. In certain embodiments, the diameter of the macropores is estimated by one of the techniques described herein. In certain embodiments, the diameter of the macropores is calculated by capillary flow porometry.

In certain embodiments, the invention relates to any one of the aforementioned composite materials, wherein the average pore diameter of the macropores is about 25 nm to about 1500 nm.

In certain embodiments, the invention relates to any one of the aforementioned composite materials, wherein the average pore diameter of the macropores is about 50 nm to about 1000 nm. In certain embodiments, the invention relates to any one of the aforementioned composite materials, wherein the average pore diameter of the macropores is about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, or about 700 nm.

In certain embodiments, the invention relates to any one of the aforementioned composite materials, wherein the average pore diameter of the macropores is from about 300 nm to about 400 nm.

In certain embodiments, the invention relates to any one of the aforementioned composite materials, wherein the composite material is a membrane.

In certain embodiments, the invention relates to any one of the aforementioned composite materials, wherein the support member has a void volume; and the void volume of the support member is substantially filled with the macroporous cross-linked gel.

In certain embodiments, the invention relates to any one of the aforementioned composite materials, wherein the support member comprises a polymer; the support member is about 10 μm to about 500 μm thick; the pores of the support member have an average pore diameter of about 0.1 μm to about 25 μm. In certain embodiments, the support member has a volume porosity of about 40% to about 90%.

In certain embodiments, the invention relates to any one of the aforementioned composite materials, wherein the thickness of the support member is about 10 μm to about 1000 μm. In certain embodiments, the invention relates to any one of the aforementioned composite materials, wherein the thickness of the support member is about 10 μm to about 500 μm. In certain embodiments, the invention relates to any one of the aforementioned composite materials, wherein the thickness of the support member is about 30 μm to about 300 μm. In certain embodiments, the invention relates to any one of the aforementioned composite materials, wherein the thickness of the support member is about 30 μm, about 50 μm, about 100 μm, about 150 μm, about 200 μm, about 250 μm, or about 300 μm.

In certain embodiments, the invention relates to any one of the aforementioned composite materials, wherein the pores of the support member have an average pore diameter of about 0.1 μm to about 25 μm. In certain embodiments, the invention relates to any one of the aforementioned composite materials, wherein the pores of the support member have an average pore diameter of about 0.5 μm to about 15 μm. In certain embodiments, the invention relates to any one of the aforementioned composite materials, wherein the pores of the support member have an average pore diameter of about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, or about 15 μm.

In certain embodiments, the invention relates to any one of the aforementioned composite materials, wherein the support member has a volume porosity of about 40% to about 90%. In certain embodiments, the invention relates to any one of the aforementioned composite materials, wherein the support member has a volume porosity of about 50% to about 80%. In certain embodiments, the invention relates to any one of the aforementioned composite materials, wherein the support member has a volume porosity of about 50%, about 60%, about 70%, or about 80%.

In certain embodiments, the invention relates to any one of the aforementioned composite materials, wherein the support member comprises a polyolefin.

In certain embodiments, the invention relates to any one of the aforementioned composite materials, wherein the support member comprises a polymeric material selected from the group consisting of polysulfones, polyethersulfones, polyphenyleneoxides, polycarbonates, polyesters, cellulose and cellulose derivatives.

In certain embodiments, the invention relates to any one of the aforementioned composite materials, wherein the support member comprises a fibrous woven or non-woven fabric comprising a polymer; the support member is from about 10 μm to about 2000 μm thick; the pores of the support member have an average pore diameter of from about 0.1 μm to about 25 μm; and the support member has a volume porosity of about 40% to about 90%.

### Exemplary Methods

In certain embodiments, the invention relates to a method, comprising the step of:
contacting at a first flow rate a first fluid comprising a substance with any one of the aforementioned composite materials, thereby adsorbing or absorbing a portion of the substance onto the composite material.

In certain embodiments, the first fluid further comprises a fragmented antibody, aggregated antibodies, a host cell protein, a polynucleotide, an endotoxin, or a virus.

In certain embodiments, the invention relates to any one of the aforementioned methods, wherein the fluid flow path of the first fluid is substantially through the macropores of the composite material.

In certain embodiments, the invention relates to any one of the aforementioned methods, further comprising the step of:
contacting at a second flow rate a second fluid with the substance adsorbed or absorbed onto the composite material, thereby releasing a first portion of the substance from the composite material.

In certain embodiments, the invention relates to any one of the aforementioned methods, wherein the fluid flow path of the second fluid is substantially through the macropores of the composite material.

In certain embodiments, the invention relates to any one of the aforementioned methods, further comprising the step of:
contacting at a third flow rate a third fluid with the substance adsorbed or absorbed onto the composite material, thereby releasing a second portion of the substance from the composite material.

In certain embodiments, the invention relates to any one of the aforementioned methods, wherein the substance is a biological molecule or biological ion.

In certain embodiments, the invention relates to any one of the aforementioned methods, wherein the biological molecule or biological ion is selected from the group consisting of albumins, lysozyme, viruses, cells, γ-globulins of human and animal origins, immunoglobulins of human and animal origins, proteins of recombinant and natural origins, polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, nucleic acid derived products, DNA of synthetic and natural origins, and RNA of synthetic and natural origins.

In certain embodiments, the invention relates to any one of the aforementioned methods, wherein the biological molecule or biological ion is lysozyme, hIgG, myoglobin, human serum albumin, soy trypsin inhibitor, transferring, enolase, ovalbumin, ribonuclease, egg trypsin inhibitor, cytochrome c, Annexin V, or α-chymotrypsinogen.

In certain embodiments, the invention relates to any one of the aforementioned methods, wherein the first fluid is a buffer. In certain embodiments, the invention relates to any one of the aforementioned methods, wherein the concentration of the buffer in the first fluid is about 5 mM, about 10 mM, about 15 mM, about 20 mM, about 25 mM, about 30 mM, about 35 mM, about 40 mM, about 50 mM, about 60 mM, about 70 mM, about 75 mM, about 80 mM, about 85 mM, about 90 mM, about 95 mM, about 0.1 M, about 0.11 M, about 0.12 M, about 0.13 M, about 0.14 M, about 0.15 M, about 0.16 M, about 0.17 M, about 0.18 M, about 0.19 M or about 0.2 M. In certain embodiments, the invention relates to any one of the aforementioned methods, wherein the pH of the first fluid is about 2, about 2.5, about 3, about 3.5, about 4, about 4.5, about 5, about 5.5, about 6, about 7, about 8, or about 9.

In certain embodiments, the invention relates to any one of the aforementioned methods, wherein the first fluid comprises sodium acetate. In certain embodiments, the invention relates to any one of the aforementioned methods, wherein the first fluid comprises sodium citrate. In certain embodiments, the invention relates to any one of the aforementioned methods, wherein the first fluid comprises 2-(N-morpholino)ethanesulfonic acid.

In certain embodiments, the invention relates to any one of the aforementioned methods, wherein the concentration of the substance in the first fluid is about 0.2 mg/mL to about 10 mg/mL. In certain embodiments, the invention relates to any one of the aforementioned methods, wherein the concentration of the substance in the first fluid is about 0.2 mg/mL, about 0.3 mg/mL, about 0.4 mg/mL, about 0.5 mg/mL, about 0.6 mg/mL, about 0.7 mg/mL, about 0.8 mg/mL, about 0.9 mg/L, about 1 mg/mL, about 1.2 mg/mL, about 1.4 mg/mL, about 1.6 mg/mL, about 1.8 mg/mL, about 2 mg/mL, about 3 mg/mL, about 4 mg/mL, about 5 mg/mL, about 6 mg/mL, about 7 mg/mL, about 8 mg/mL, about mg/mL, or about 10 mg/mL.

In certain embodiments, the invention relates to any one of the aforementioned methods, wherein the first flow rate is up to about 50 bed volumes/min. In certain embodiments, the invention relates to any one of the aforementioned methods, wherein the first flow rate is about 5 bed volumes/min, about 10 bed volumes/min, about 20 bed volumes/min, about 30 bed volumes/min, about 40 bed volumes/min, or about 50 bed volumes/min.

In certain embodiments, the invention relates to any one of the aforementioned methods, wherein the first flow rate is about 0.5 mL/min to about 2 mL/min. In certain embodiments, the invention relates to any one of the aforementioned methods, wherein the first flow rate is about 0.5 mL/min, about 0.6 mL/min, about 0.7 mL/min, about 0.8 mL/min, about 0.9 mL/min, about 1 mL/min, about 1.1 mL/min, about 1.2 mL/min, about 1.3 mL/min, about 1.4 mL/min, about 1.5 mL/min, about 1.6 mL/min, about 1.7 mL/min, or about 1.8 mL/min.

In certain embodiments, the invention relates to any one of the aforementioned methods, wherein the second fluid is a buffer. In certain embodiments, the invention relates to any one of the aforementioned methods, wherein the second fluid comprises 2-(N-morpholino)ethanesulfonic acid or sodium acetate. In certain embodiments, the invention relates to any one of the aforementioned methods, wherein the second fluid comprises 2-(N-morpholino)ethanesulfonic acid or sodium acetate in a concentration of about 5 mM to about 2M. In certain embodiments, the invention relates to any one of the aforementioned methods, wherein the second fluid comprises 2-(N-morpholino)ethanesulfonic acid or sodium acetate in about 5 mM, about 10 mM, about 20 mM, about 30 mM, about 40 mM, about 50 mM, about 60 mM, about 70 mM, about 80 mM, about 90 mM, about 100 mM, about 125 mM, about 150 mM, about 200 mM, about 300 mM, or about 400 mM.

In certain embodiments, the invention relates to any one of the aforementioned methods, wherein the pH of the second fluid is about 4 to about 8. In certain embodiments, the invention relates to any one of the aforementioned methods, wherein the pH of the second fluid is about 4, about 4.2, about 4.4, about 4.6, about 4.8, about 5, about 5.2, about 5.4, about 5.5, about 5.6, about 5.7, about 5.8, about 5.9, about 6, about 6.2, or about 6.4.

In certain embodiments, the invention relates to any one of the aforementioned methods, wherein the second fluid comprises a salt. In certain embodiments, the invention relates to any one of the aforementioned methods, wherein the salt is selected from the group consisting of glycine-HCl, NaCl, and NH₄Cl. In certain embodiments, the invention relates to any one of the aforementioned methods, wherein the salt concentration in the second fluid is about 70 mM to about 2 M. In certain embodiments, the invention relates to any one of the aforementioned methods, wherein the salt concentration is about 70 mM, about 80 mM, about 90 mM, about 100 mM, about 110 mM, about 115 mM, about 120 mM, about 125 mM, about 130 mM, about 135 mM, about 140 mM, about 145 mM, about 150 mM, about 160 mM, about 170 mM, about 180 mM, about 190 mM, about 200 mM, about 250 mM, about 300 mM, about 350 mM, about 400 mM, about 450 mM, about 500 mM, about 550 mM, about 600 mM, about 650 mM, about 700 mM, about 750 mM, about 800 mM, about 850 mM, about 900 mM, about 950 mM, about 1 M, about 1.1 M, about 1.2 M, about 1.3 M, about 1.4 M, about 1.5 M, about 1.6 M, about 1.7 M, about 1.8 M, about 1.9 M, or about 2 M.

In certain embodiments, the invention relates to any one of the aforementioned methods, wherein the third fluid is a buffer.

In certain embodiments, the invention relates to any one of the aforementioned methods, further comprising the steps of:

cleaning the composite material; and

repeating the above-mentioned steps.

In certain embodiments, the invention relates to any one of the aforementioned methods, wherein the composite material is cleaned with a basic solution. In certain embodiments, the invention relates to any one of the aforementioned methods, wherein the composite material is cleaned with a fourth fluid; and the fourth fluid comprises sodium hydroxide.

In certain embodiments, the invention relates to any one of the aforementioned methods, wherein substantially all of the substance is adsorbed or absorbed onto the composite material.

In certain embodiments, the invention relates to a method, comprising the step of:
contacting at a first flow rate a first fluid comprising a substance and an unwanted material with any one of the aforementioned composite materials, thereby adsorbing or absorbing a portion of the unwanted material onto the composite material.

In certain embodiments, the invention relates to any one of the aforementioned methods, wherein the unwanted material comprises a fragmented antibody, aggregated antibodies, a host cell protein, a polynucleotide, an endotoxin, or a virus.

In certain embodiments, the invention relates to any one of the aforementioned methods, wherein substantially all of the unwanted material is adsorbed or absorbed onto the composite material.

In certain embodiments, the invention relates to any one of the aforementioned methods, wherein the fluid flow path of the first fluid is substantially through the macropores of the composite material.

In certain embodiments, the invention relates to any one of the aforementioned methods, wherein the substance is a biological molecule or biological ion.

In certain embodiments, the invention relates to any one of the aforementioned methods, wherein the biological molecule or biological ion is selected from the group consisting of albumins, lysozyme, viruses, cells, γ-globulins of human and animal origins, immunoglobulins of human and animal origins, proteins of recombinant and natural origins, polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, nucleic acid derived products, DNA of synthetic and natural origins, and RNA of synthetic and natural origins.

In certain embodiments, the invention relates to any one of the aforementioned methods, wherein the biological molecule or biological ion is lysozyme, hIgG, myoglobin, human serum albumin, soy trypsin inhibitor, transferring, enolase, ovalbumin, ribonuclease, egg trypsin inhibitor, cytochrome c, Annexin V, or α-chymotrypsinogen.

In certain embodiments, the invention relates to any one of the aforementioned methods, wherein the first fluid is a buffer. In certain embodiments, the invention relates to any one of the aforementioned methods, wherein the concentration of the buffer in the first fluid is about 20 mM, about 30 mM, about 40 mM, about 50 mM, about 60 mM, about 70 mM, about 75 mM, about 80 mM, about 85 mM, about 90 mM, about 95 mM, about 0.1 M, about 0.11 M, about 0.12 M, about 0.13 M, about 0.14 M, about 0.15 M, about 0.16 M, about 0.17 M, about 0.18 M, about 0.19 M or about 0.2 M.

In certain embodiments, the invention relates to any one of the aforementioned methods, wherein the first fluid comprises sodium acetate. In certain embodiments, the invention relates to any one of the aforementioned methods, wherein the first fluid comprises sodium citrate. In certain embodiments, the invention relates to any one of the aforementioned methods, wherein the first fluid comprises sodium phosphate, tris(hydroxymethyl)aminomethane, tris(hydroxymethyl)aminomethane HCl, or 2-(N-morpholino)ethanesulfonic acid.

In certain embodiments, the invention relates to any one of the aforementioned methods, wherein the first fluid comprises a salt. In certain embodiments, the invention relates to any one of the aforementioned methods, wherein the salt is selected from the group consisting of glycine-HCl, NaCl, and NH₄Cl. In certain embodiments, the invention relates to any one of the aforementioned methods, wherein the first fluid comprises sodium chloride. In certain embodiments, the invention relates to any one of the aforementioned methods, wherein the first fluid comprises sodium chloride in a concentration of about 10 mM to about 600 mM. In certain embodiments, the invention relates to any one of the aforementioned methods, wherein the first fluid comprises sodium chloride in a concentration of about 50 mM, about 75 mM, about 100 mM, about 125 mM, about 150 mM, about 175 mM, about 200 mM, about 225 mM, about 250 mM, about 275 mM, about 300 mM, about 325 mM, about 350 mM, about 375 mM, about 400 mM, about 425 mM, about 450 mM, about 475 mM, about 500 mM, or about 525 mM.

In certain embodiments, the invention relates to any one of the aforementioned methods, wherein the first flow rate is about 0.5 mL/min to about 2 mL/min. In certain embodiments, the invention relates to any one of the aforementioned methods, wherein the first flow rate is about 0.5 mL/min, about 0.6 mL/min, about 0.7 mL/min, about 0.8 mL/min, about 0.9 mL/min, about 1 mL/min, about 1.1 mL/min, about 1.2 mL/min, about 1.3 mL/min, about 1.4 mL/min, about 1.5 mL/min, about 1.6 mL/min, about 1.7 mL/min, or about 1.8 mL/min.

In certain embodiments, the invention relates to any one of the aforementioned methods, wherein the first fluid is a clarified cell culture supernatant.

In certain embodiments, the invention relates to a method of making a composite material, comprising the steps of:

combining a first monomer, a photoinitiator, a cross-linking agent, and a solvent, wherein the first monomer does not comprise ester functionality; and the cross-linker does not comprise ester functionality, thereby forming a monomeric mixture;

contacting a support member with the monomeric mixture, thereby forming a modified support member; wherein the support member comprises a plurality of pores extending through the support member, and the average pore diameter of the pores is about 0.1 to about 25 μm;

covering the modified support member with a polymeric sheet, thereby forming a covered support member; and

irradiating the covered support member for a period of time, thereby forming a composite material.

In certain embodiments, the invention relates to any one of the aforementioned methods, further comprising the step of washing the composite material with a second solvent, thereby forming a washed composite material. In certain embodiments, the second solvent is water.

In certain embodiments, the invention relates to any one of the aforementioned methods, further comprising the step of contacting the composite material or the washed composite material with a salt solution.

In certain embodiments, the salt solution comprises sodium chloride. In certain embodiments, the salt solution comprises sodium chloride in a concentration of about 0.05 N to about 5 N. In certain embodiments, the salt solution comprises sodium chloride in about 0.06 N, about 0.07 N, about 0.08 N, about 0.09 N, about 0.1 N, about 0.11 N, about 0.12 N, about 0.13 N, about 0.14 N, about 0.15 N, about 0.18 N, about 0.2 N, about 0.22 N, about 0.24 N, about 0.26 N, about 0.28 N, about 0.3 N, about 0.32 N, about 0.34 N, about 0.36 N, about 0.38 N, about 0.4 N, about 0.42 N, about 0.44 N, about 0.46 N, about 0.48 N, about 0.5 N, about 0.6 N, about 0.7 N, about 0.8 N, about 0.9 N, about 1 N, about 1.5 N, about 2 N, about 2.5 N, about 3 N, about 3.5 N, about 4 N, about 4.5 N, or about 5 N.

In certain embodiments, the invention relates to any one of the aforementioned methods, further comprising the step of removing any excess monomeric mixture from the covered support member.

In certain embodiments, the invention relates to any one of the aforementioned methods, wherein the monomer mixture comprises acrylamide, N-acryloxysuccinimide, N,N-diethylacrylamide, N,N-dimethylacrylamide, N-[3-(N,N-dimethylamino)propyl]methacrylamide, N,N-dimethylacrylamide, methacrylamide, N-isopropylacrylamide, styrene, 4-vinylpyridine, vinylsulfonic acid, N-vinyl-2-pyrrolidinone (VP), acrylamido-2-methyl-1-propanesulfonic acid, N-(hydroxymethyl)acrylamide, N-(isobutoxymethyl)acrylamide, N-(hydroxyethyl)acrylamide, N-(3-Methoxypropyl)acrylamide, 2-acrylamidoglycolic acid, N-vinylformamide, N-[tris(hydroxymethyl)methyl]acrylamide, 3-acryloylamino-1-propanol, styrenesulfonic acid, (3-acrylamidopropyl)trimethylammonium halide, diallyldimethylammonium halide, 4-vinyl-N-methylpyridinium halide, vinylbenzyl-N-trimethylammonium halide, omethacryloxyethyltrimethylammonium halide, N-acrylamido polyethylenimine, N-methacrylamido polyethylenimine, N-acrylamido 4-arm amine-terminated poly(ethylene oxide), N-methacrylamido 4-arm amine-terminated poly(ethylene oxide), N-acrylamido trimethylolpropane tris[poly(propylene glycol)amine-terminated]ether, N-methacrylamido trimethylolpropane tris[poly(propylene glycol)amine-terminated]ether, N-acrylamido amine-terminate poly(N-isopropylacrylamide), N-methacrylamido amine-terminate poly(N-isopropylacrylamide), N-acrylamido poly-L-arginine hydrochloride, N-methacrylamido poly-L-arginine hydrochloride, N-acrylamido poly(ethylene glycol) bis(amine), N-methacrylamido poly(ethylene glycol) bis(amine), N-acrylamido poly(allylamine hydrochloride), N-methacrylamido poly(allylamine hydrochloride), N-acrylamido poly(dimethylamine-co-epichlorohydrin-co-ethylenediamine), N-methacrylamido poly(dimethylamine-co-epichlorohydrin-co-ethylenediamine), or diacetone acrylamide.

In certain embodiments, the invention relates to any one of the aforementioned methods, wherein the monomer mixture comprises an amine-containing compound and acryloyl chloride, 3-ethoxyacryloyl chloride, 4-methoxycinnamoyl chloride, or 3-acryloyl-1,3-oxazolidin-2-one. In certain embodiments, the amine-containing compound is polyethylenimine, 4-arm amine-terminated poly(ethylene oxide), trimethylolpropane tris[poly(propylene glycol), amine terminated]ether, amine-terminate poly(N-isopropylacrylamide), poly-L-arginine hydrochloride, poly(ethylene glycol) bis(amine), poly(allylamine hydrochloride), or poly(dimethylamine-co-epichlorohydrin-co-ethylenediamine).

In certain embodiments, the invention relates to any one of the aforementioned methods, wherein the monomer mixture comprises bisacrylamidoacetic acid, 2,2-bis[4-(2-acryloxyethoxy)phenyl]propane, 2,2-bis(4-methacryloxyphenyl)propane, 1,4-butanediol divinyl ether, 1,4-diacryloylpiperazine, diallylphthalate, N,N-dodecamethylenebisacrylamide, divinylbenzene, glycerol tris(acryloxypropyl)ether, N,N′-hexamethylenebisacrylamide, triethylene glycol divinyl ether, diallyl diglycol carbonate, poly(ethylene glycol) divinyl ether, N,N′-dimethacryloylpiperazine, divinyl glycol, N,N′-methylenebisacrylamide, N,N′-ethylenebis(acrylamide), N,N′-(1,2-dihydroxyethylene)bis-acrylamide, N,N′-hexamethylenebis(methacrylamide), N,N′-octamethylenebisacrylamide, N,N′-dimethacryloylpiperazine, 1,3,5-triacryloylhexahydro-1,3,5-triazine, or divinylbenzene.

In certain embodiments, the invention relates to any one of the aforementioned methods, wherein the monomer mixture comprises N,N′-methylenebisacrylamide, N,N′-hexamethylenebis(methacrylamide), 1,3,5-triacryloylhexahydro-1,3,5-triazine, or divinylbenzene.

In certain embodiments, the invention relates to any one of the aforementioned methods, wherein the monomer mixture comprises more than one monomer. In certain embodiments, the invention relates to any one of the aforementioned methods, wherein the monomer mixture further comprises a second monomer.

In certain embodiments, the invention relates to any one of the aforementioned methods, wherein the composite material is any one of the aforementioned composite materials.

In certain embodiments, the invention relates to any one of the aforementioned methods, wherein the monomers are present in the solvent in about 6% to about 38% (w/w), collectively.

In certain embodiments, the invention relates to any one of the aforementioned methods, wherein the monomers are present in the solvent in an amount of about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, or about 38% (w/w), collectively.

In certain embodiments, the invention relates to any one of the aforementioned methods, wherein the photoinitiator is present in the monomeric mixture in an amount of about 0.1% (w/w) to about 2.5% (w/w) relative to the total weight of monomer.

In certain embodiments, the invention relates to any one of the aforementioned methods, wherein the photoinitiator is present in the monomeric mixture in about 0.1%, about 0.2%, about 0.3%, about 0.4%, about 0.5% about 0.6%, about 0.8%, about 1.0%, about 1.2%, or about 1.4% (w/w) relative to the total weight of monomer.

In certain embodiments, the invention relates to any one of the aforementioned methods, wherein the photoinitiator is selected from the group consisting of 1-[4-(2-hydroxyethoxy)-phenyl]-2-hydroxy-2-methyl-1-propane-1-one, 2,2-dimethoxy-2-phenylacetophenone, benzophenone, benzoin and benzoin ethers, dialkoxyacetophenones, hydroxyalkylphenones, and α-hydroxymethyl benzoin sulfonic esters.

In certain embodiments, the invention relates to any one of the aforementioned methods, wherein the solvent comprises 1,3-butanediol, di(propylene glycol) propyl ether, N,N-dimethylacetamide, di(propylene glycol) dimethyl ether, 1,2-propanediol, di(propylene glycol) methyl ether acetate (DPMA), water, dioxane, dimethylsulfoxide (DMSO), dimethylformamide (DMF), acetone, ethanol, N-methylpyrrolidone (NMP), tetrahydrofuran (THF), ethyl acetate, acetonitrile, N-methylacetamide, propanol, tri(propylene glycol) propyl ether, tri(propylene glycol) butyl ether, di(propylene glycol) propyl ether, or methanol.

In certain embodiments, the invention relates to any one of the aforementioned methods, wherein the solvent comprises N,N-dimethylacetamide. In certain embodiments, the invention relates to any one of the aforementioned methods, wherein the solvent comprises N,N-dimethylacetamide in an amount of about 15% to about 44% by weight. In certain embodiments, the invention relates to any one of the aforementioned methods, wherein the solvent comprises N,N-dimethylacetamide in about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 42%, or about 44% by weight.

In certain embodiments, the invention relates to any one of the aforementioned methods, wherein the solvent comprises di(propylene glycol) methyl ether acetate. In certain embodiments, the invention relates to any one of the aforementioned methods, wherein the solvent comprises di(propylene glycol) methyl ether acetate in an amount of about 15% to about 80% by weight. In certain embodiments, the invention relates to any one of the aforementioned methods, wherein the solvent comprises di(propylene glycol) methyl ether acetate in about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 42%, about 44%, about 46%, about 48%, about 50%, about 55%, about 60%, about 65%, about 70%, about 75%, or about 80% by weight.

In certain embodiments, the invention relates to any one of the aforementioned methods, wherein the solvent comprises 1,3-butanediol. In certain embodiments, the invention relates to any one of the aforementioned methods, wherein the solvent comprises 1,3-butanediol in an amount of about 0.5% to about 6% by weight. In certain embodiments, the invention relates to any one of the aforementioned methods, wherein the solvent comprises 1,3-butanediol in about 0.5%, about 1%, about 1.5%, about 2%, about 2.5%, about 3%, about 3.5%, about 4%, about 4.5%, or about 5% by weight.

In certain embodiments, the invention relates to any one of the aforementioned methods, wherein the solvent comprises water. In certain embodiments, the invention relates to any one of the aforementioned methods, wherein the solvent comprises water in an amount of about 0.5% to about 6% by weight. In certain embodiments, the invention relates to any one of the aforementioned methods, wherein the solvent comprises water in about 0.5%, about 1%, about 1.5%, about 2%, about 2.5%, about 3%, about 3.5%, about 4%, about 4.5%, or about 5% by weight.

In certain embodiments, the invention relates to any one of the aforementioned methods, wherein the solvent comprises di(propylene glycol) dimethyl ether. In certain embodiments, the invention relates to any one of the aforementioned methods, wherein the solvent comprises di(propylene glycol) dimethyl ether in an amount of about 1% to about 75% by weight. In certain embodiments, the invention relates to any one of the aforementioned methods, wherein the solvent comprises di(propylene glycol) dimethyl ether in about 1%, about 1.5%, about 2%, about 2.5%, about 3%, about 3.5%, about 4%, about 4.5%, about 5%, about 10%, about 15%, about 20%, about 25%, about 30%, about 35%, about 40%, about 45%, about 50%, about 55%, about 60%, about 65%, about 70%, or about 75% by weight.

In certain embodiments, the invention relates to any one of the aforementioned methods, wherein the solvent comprises tri(propylene glycol) butyl ether. In certain embodiments, the invention relates to any one of the aforementioned methods, wherein the solvent comprises tri(propylene glycol) butyl ether in an amount of about 3% to about 60% by weight. In certain embodiments, the invention relates to any one of the aforementioned methods, wherein the solvent comprises tri(propylene glycol) butyl ether in about 3%, about 3.5%, about 4%, about 4.5%, about 5%, about 10%, about 15%, about 20%, about 25%, about 30%, about 35%, about 40%, about 45%, about 50%, about 55%, or about 60% by weight.

In certain embodiments, the invention relates to any one of the aforementioned methods, wherein the solvent comprises di(propylene glycol) propyl ether. In certain embodiments, the invention relates to any one of the aforementioned methods, wherein the solvent comprises di(propylene glycol) propyl ether in an amount of about 1% to about 30% by weight. In certain embodiments, the invention relates to any one of the aforementioned methods, wherein the solvent comprises di(propylene glycol) propyl ether in about 1%, about 1.5%, about 2%, about 2.5%, about 3%, about 3.5%, about 4%, about 4.5%, about 5%, about 10%, about 15%, about 20%, about 25%, or about 30% by weight.

In certain embodiments, the invention relates to any one of the aforementioned methods, wherein the cross-linking agent is present in the solvent in about 0.3% to about 4% (w/w).

In certain embodiments, the invention relates to any one of the aforementioned methods, wherein the cross-linking agent is present in the solvent in an amount of about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.2%, about 2.4%, about 2.6%, about 2.8%, about 3%, about 3.2%, about 3.4%, about 3.6%, about 3.8%, or about 4% (w/w).

In certain embodiments, the invention relates to any one of the aforementioned methods, wherein the covered support member is irradiated at about 350 nm.

In certain embodiments, the invention relates to any one of the aforementioned methods, wherein the period of time is about 1 minute, about 5 minutes, about 10 minutes, about 15 minutes, about 20 minutes, about 30 minutes, about 45 minutes, or about 1 hour.

In certain embodiments, the invention relates to any one of the aforementioned methods, wherein the composite material comprises macropores.

In certain embodiments, the invention relates to any one of the aforementioned methods, wherein the average pore diameter of the macropores is less than the average pore diameter of the pores.

### EXEMPLIFICATION

The following examples are provided to illustrate the invention. It will be understood, however, that the specific details given in each example have been selected for purpose of illustration and are not to be construed as limiting the scope of the invention. Generally, the experiments were conducted under similar conditions unless noted.

### Example 1

### General Materials and Methods

Chemicals (Obtained from Aldrich):

2-acrylamido-2-methyl-1-propanesulfonic acid (AMPS), N-(hydroxymethyl)acrylamide solution (48% in H₂O), N-(isobutoxymethyl)acrylamide, N,N′-hexamethylenebis(methacrylamide), 1,3,5-triacryloylhexahydro-1,3,5-triazine, N,N′-dimethylacetamide (DMAc), di(propylene glycol) dimethyl ether, mixture of isomers (DPM), Di(propylene glycol)methyl ether acetate (DPMA), tri(propylene glycol) butyl ether mixture of isomers, Di(propylene glycol) propyl ether, mixture of isomers. (±)-1,3-Butanediol (Budiol), 4-(2-Hydroxyethoxy)phenyl-(2-hydroxy-2-propyl)ketone (IRGACURE 2959). Sodium (sod.) acetate trihydrate, acetic acid (glacial), 2-(N-morpholino)ethanesulfonic acid (MES).

### Proteins:

Polyclonal immuno γ-globulin IgG (Equitech Inc.), egg lysozyme (Sigma-Aldrich).

### Making the Membrane:

The monomers and crosslinker(s) were added to specific solvent mixture as well as the Irgacure initiator, and the mixture was stirred long enough to ensure all ingredients properly dissolved in the solution system. A 7″×7″ support substrate sheet (polypropylene) was placed on polyethylene sheet, then 15 g of the polymer solution was introduced to the substrate sheet, and the impregnated substrate was subsequently covered with another polyethylene sheet. The sheet was pressed gently with hand in circular motion in order to remove excess solution and any entrapped air bubbles. Polymerization process was initiated by applying UV irradiation (˜350 nm) to the sheets sandwich in a closed chamber for 10 min. The resultant membrane was then removed from the polyethylene sheets cover and washed using R.O. water, soaked in salt solution (2 M NaCl-30 min), and washed with R.O. water (2-3 times) with agitation. The clean membranes were dried, either by being replaced in oven (50° C.) for 30 minutes, or by hanging freely in the air at ambient conditions for ˜16 hours.

### Binding Capacity Measurement:

a) IgG binding: 25-mm membrane disc was placed in 25-mm Natrix-SS holder and 20 mL of binding buffer (20 mM sodium citrate, pH 5.0) was passed through to achieve equilibration. Then protein solution of 0.5 mg/mL polyclonal IgG (Equitech Inc.) in binding buffer was passed through until the UV absorbance of the effluent exceeded 10% of the feeding solution, and then 10-15 mL of buffer was passed through the cell to wash unbound protein. In elution step, the bound IgG was eluted by passing 10 mL of elution buffer (20 mM sod. acetate, 1 M NaCl, pH 5.0).
b) Lysozyme binding: 25-mm membrane disc was placed in 25-mm Natrix-SS holder and 20 mL of binding buffer (10 mM MES, pH 5.5) was passed through to achieve equilibration. Then protein solution of 0.5 mg/mL lysozyme (from egg) (Sigma-Aldrich) in binding buffer was passed through until the UV absorbance of the effluent exceeded 10% of the feeding solution, and then 10-15 mL of buffer was passed through the cell to wash unbound protein. In elution step, the bound protein was eluted by passing 10 mL of elution buffer (10 mM MES, 1 M NaCl, pH 5.5).
c) Multicycle IgG binding: the experiment was carried out using Akta Explorer (GE) instrument. 25-mm membrane disc was placed in 25-mm Natrix-SS holder and connected to the instrument. 5 mL of sodium hydroxide solution (0.5 mL) was passed through the membrane at 1 mL/min flow rate. Then 10 mL of sodium acetate buffer of 200 mM (pH 5.0) was passed through the membrane at 1 mL/min in order to restore the pH level within the gel, then 30 mL of binding buffer (20 mM sod. citrate, pH 5.0) was passed through to achieve equilibration. Then 16-18 mL of protein solution of 0.5 mg/mL polyclonal IgG (Equitech Inc.) in binding buffer was passed through so the UV absorbance of the effluent exceed 10% of the feeding solution, and then 10 mL of buffer was passed through the cell to wash unbound protein. In elution step, the bound IgG was eluted by passing 10 mL of elution buffer (20 mM sod. acetate, 1 M NaCl, pH 5.0). The pass through, wash, and elution fractions were collected and UV absorbance (at 280 nm) were measured to determine the amount of protein that was captured and eluted so that recovery % can be estimated.

### Pore Size Measurements

### Experimental Procedure

Membrane pore size (i.e., diameter) was measured using a CFP-1500-AE Capillary Flow Porometer (Porous Materials Inc., Ithaca N.Y.), operated by CapWin software (V.6). Distilled water was used as the testing solution.

A small disc of membrane (2.5-cm diameter) was soaked in distilled water for 10 min., then it was gently squeezed between two pre-wetted filter paper discs (Whatman 5-70 mm) to remove excess water, and the thickness of the wetted membrane was determined using a micrometer. The membrane disc was then placed on a 2.5-cm stainless steel mesh support disc. The support disc loaded with the test membrane was placed in the designated holder, with the membrane facing up. The metal cover was then gently placed on the holder and the test was run within the pressure range of 0-200 psi.

Porometry Data:

Pore size measurements were performed on several membrane formulation samples (formula details are given in FIG. 34 and FIG. 38). 2-3 samples of each membrane formula shown below were examined. Mean flow-through pore size measurements were determined and are presented along with the corresponding dynamic human IgG binding capacity (DBC) at 10% breakthrough and buffer solution flux. All entries are average measurements±standard deviation. See FIG. 64.

### Example 2

### Caustic Stability of Membranes Made with Acrylate Crosslinkers

The typical S membrane (strong cation exchange) polymerization mixture is composed of 1.695 g (11.3 wt %) of 2-acrylamido-2-methyl-1-propanesulfonic acid (AMPS), 0.194 g (1.29 wt %) of trimethylolpropane triacrylate (TRIM-A), 0.03 g (0.2 wt %) Irgacure initiator, 3.923 g (26.15 wt %) N,N′-dimethylacetamide (DMAc), 8.874 g (59.16 wt %) di(propylene glycol)methyl ether acetate (DPMA), and 0.285 g (1.9 wt %) of D.I. water.

Membrane coupons (77 cm in diameter) of S and C membranes (wherein the macroporous cross-linked gel in the membrane is cross-linked with acrylate-based cross-linkers) were soaked in sodium hydroxide solution of 1 M and 0.1 M at room temperature for 4 and 24 hours, then flux and in some cases binding capacity were measured (using water and/or buffer solution).

Results suggest, as shown in FIG. 13 and FIG. 14, that exposure to sodium hydroxide solution reduced the membrane permeability as indicated by flux reduction. The deteriorating effect of the base on membrane was amplified by exposure time and/or base solution concentration.

### Example 3

### Base-Stable Membrane Made with AMPS & Bis Crosslinker

Several solvent systems were examined in formulas that were essentially based on 2-acrylamido-2-methyl-1-propanesulfonic acid (AMPS) as functional monomer and N,N′-methylenebis(acrylamide) (Bis) as a crosslinker. Irgacure (2959) was used as photo-initiator to start the polymerization upon UV irradiation.

Solvent System A1

This solvent system includes N,N′-dimethylacetamide (DMAc), di(propylene glycol)methyl ether acetate (DPMA), 1,3 butanediol (1,3-Budiol), and deionized water (D.I.). Formulas based on this solvent system with some ingredients variation are listed in FIG. 15.

The polymerization mixture of each formula was formulated and mixed well before being used to cast the membrane (as previously described). Initial flux (using R.O. water as a solute) of each membrane's coupon was measured, then the coupon was soaked in 1 M sodium hydroxide at room temperature for 24 hours, afterward the membrane was flushed with water then the flux was measured again, and the ratio of flux (before and after) was calculated. Protein binding capacity (IgG and/or lysozyme) was also measured as described above.

Results, as shown in FIG. 16, indicated that despite variation in the formula components, which resulted in different flux and binding capacity, the membrane flux was not affected after being exposed to caustic solution for prolonged period of time, and compared to the original S membrane formula (Example 2), which totally lost its permeability after caustic exposure, the new membrane preserved its original permeability.

Solvent System A2

This solvent system includes N,N′-dimethylacetamide (DMAc), di(propylene glycol) dimethyl ether, mixture of isomers (DPM), tri(propylene glycol) butyl ether mixture of isomers (TPGBE) and deionized water (D.I.). Formulas based on this solvent system were formulated according to FIG. 17 and membranes were casted and polymerized as described previously.

Initial flux of each membrane's coupon (7.7 cm in diameter) was measured using R.O. water as solute. The membrane coupons were subsequently soaked in 1 M sodium hydroxide at room temperature for 24 hours, afterward the membrane was flushed with R.O. water and the flux was re-measured. Ratio of flux (before and after) was calculated to demonstrate changes in flux. Protein binding capacity (IgG and/or lysozyme) was also measured as previously outlines.

As shown in FIG. 18, the results showed again that the membranes, which were made of variable amounts of monomer and crosslinker, demonstrated caustic stability, and despite the diversity of the membrane permeability, as dictated by formula ingredients, each membrane was capable of maintaining its original permeability after base exposure.

Solvent System A3

This solvent system includes N,N′-dimethylacetamide (DMAc), di(propylene glycol) di(propylene glycol) dimethyl ether, mixture of isomers (DPM), dri(propylene glycol) propyl ether mixture of isomers (DPGPE) and deionized water (D.I.). As in previous systems, the membrane formulas (FIG. 19) were prepared and mixed well and used to cast and prepare as outlined previously.

Initial flux of each membrane's coupon (77 cm in diameter) was measured using R.O. water as solute, and after soaking the membrane coupons in 1 M sodium hydroxide at room temperature for 24 hours, the coupons were thoroughly flushed with R.O. water and the flux was measured again, then the flux ratio (before and after base exposure) was calculated. Similar to the previous systems, protein binding capacity (IgG and/or lysozyme) was also measured, following the procedure described earlier.

The results, as shown in FIG. 20, confirmed the caustic stability of the membrane as the permeability of each membrane was not affected by caustic solution exposure, regardless of its initial permeability. Despite the diversity of the membrane permeability, which is mainly controlled by the monomer content, crosslinking degree, and solvent system miscibility, each formula resulted in membrane that was capable of maintaining its original permeability after base exposure.

### Example 4

### Base-Stable Membrane Made with AMPS, Bis, and Additional Acrylamide Co-Monomers

In this set of examples, two additional co-monomers, namely N-(hydroxymethyl)acrylamide (NHMAA) and N-(isobutoxymethyl)acrylamide (NIBoMAA), which are basically methylacrylamide derivatives, were included in the membrane gel formulas that is based on 2-acrylamido-2-methyl-1-propanesulfonic acid (AMPS) as functional monomer and N,N′-methylenebis(acrylamide) (Bis) as a crosslinker. Irgacure (2959) is added to the formula to initiate the polymerization reaction as the UV irradiation is applied on the sample. The solvent system included N,N′-dimethylacetamide (DMAc), di(propylene glycol)methyl ether acetate (DPMA), and deionized water (D.I.). The composition of the each gel formula is shown in FIG. 21.

Similar to the previous examples, the membrane binding capacity of each membrane (for IgG and/or lysozyme) was measured then the membranes initial flux was determined before the membrane was subject to static soak in 1 M sodium hydroxide solution at room temperature for 24 hours, after which it was removed, flushed with water then the flux was re-examined, and the ratio (after/before) was calculated.

As shown in FIG. 22, all three formulas demonstrated stability as their permeability are not affected with exposure to the highly caustic solution for prolonged time. These examples showed again that it is possible to make a caustic stable gel and membrane when acrylamide crosslinker and monomers were used in the formula.

### Example 5

### Base-Stable Membranes Made with Other Acrylamide Crosslinkers

In this set of examples, new crosslinkers are used to make caustic stable membrane. The cyclic crosslinker 1,3,5-triacryloylhexahydro-1,3,5-triazine, and the bi-functional N,N′-hexamethylenebis(methacrylamide) crosslinker are used to replace N,N′-methylenebis(acrylamide) (Bis) crosslinker in the gel formula.

Membrane with 1,3,5-triacryloylhexahydro-1,3,5-triazine (TACHTA) crosslinker

A membrane was made that includes 2-acrylamido-2-methyl-1-propanesulfonic acid (AMPS) as functional monomer, 1,3,5-triacryloylhexahydro-1,3,5-triazine as a crosslinker, and Irgacure (2959) as a photoinitiator. The solvent system includes N,N′-dimethylacetamide (DMAc) and one or more of the following solvents: di(propylene glycol)methyl ether acetate (DPMA), 1,3-butandiol (1,3-Budiol), di(propylene glycol) dimethyl ether, mixture of isomers (DPM), tri(propylene glycol) butyl ether mixture of isomers (TPGBE) and deionized water (D.I.). The composition of the each gel formula is shown in FIG. 23.

Similar to the previous examples, the binding capacity of these membrane (using IgG and/or lysozyme as target molecule) was determined. In addition, each membranes initial flux was determined using coupons of 7.7 cm diameter and R.O. water as a solute, then the membranes coupons were soaked in 1 M sodium hydroxide solution at room temperature for 24 hours, after which they were removed, flushed with water, then the flux of each membrane was re-examined, and the ratio (after/before) was calculated.

Results, as shown in FIG. 24, demonstrated that all membranes, and despite of formula variations, were capable of retaining their permeability as the flux is not significantly affected by the concentrated caustic exposure. It is evident that the use of TACHTA, which is basically a tri-acrylamide crosslinker, resulted in robust caustic stable membrane.

Membrane with N,N′-hexamethylenebis(methacrylamide) (HMBis) crosslinker

A membrane was made that includes 2-acrylamido-2-methyl-1-propanesulfonic acid (AMPS) as functional monomer, N,N′-hexamethylenebis(methacrylamide) as a crosslinker, and Irgacure (2959) as a photoinitiator. The solvent system included N,N′-dimethylacetamide (DMAc) and one or more of the following solvents: di(propylene glycol)methyl ether acetate (DPMA), di(propylene glycol) dimethyl ether, mixture of isomers (DPM), dri(propylene glycol) propyl ether mixture of isomers (DPGPE), tri(propylene glycol) butyl ether mixture of isomers (TPGBE), and deionized water (D.I.). The composition of the each gel formula is shown in FIG. 25.

For each membrane, the protein binding capacity (using polyclonal IgG as a target molecule) was determined. As described previously, the initial flux of each membrane was measured using coupons of 7.7 cm diameter and R.O. water as a solute. The membranes coupons were soaked in 1 M sodium hydroxide solution at room temperature for 24 hours, then they were removed, flushed with copious amount of water, then the flux of each membrane was re-examined, and the ratio (after/before) was calculated.

Results, as shown in FIG. 26, demonstrated once again that all membranes, and despite of formula variations and membrane permeability and binding capacity, maintained their initial performance properties after exposure to the caustic solution. It is indeed possible to use N,N′-hexamethylenebis(methacrylamide) as a crosslinker to impart improved caustic stability to the membrane gel.

### Example 6

### Caustic Stable S Membrane Multicycle Performance

To demonstrate the caustic stability of S membrane that was made of acrylamide and methacrylamide crosslinkers, a membrane that was made using Bis crosslinker (formula A3-2) and a membrane sample that used HMBis as crosslinker (D-2) were subjects for multicycle run experiments that included a basic solution (0.5 M NaOH) exposure step where the basic solution was passed through the membrane at the beginning of every single bind/elute cycle, for a total of 40 cycles continuous run.

As shown in FIG. 27 and FIG. 28, both membranes have shown robust performance and consistency along the whole run as both binding capacity and recovery (>95) remained unchanged.

### Example 7

### C Membranes Stable when Exposed to NaOH

As previously illustrated with other types of gel membranes, the current C membrane in general is composed of two major parts: the crosslinked poly (meth)acrylate gel, and the inert non-woven fibrous substrate (polypropylene). The monomers and crosslinker that are used in the conventional form of this membrane are 2-carboxyethylacrylate (CEA), 2-hydroxyethylmethacrylate (HEMA), and trimethylolpropane triacrylate (TRIM-A). All these ingredients have ester linkage, which is expected to be unstable in alkaline conditions. In fact, acrylate monomers with ester linkage can undergo hydrolysis under basic conditions, and that makes the polymeric gel with its ester bonds more susceptible to basic hydrolysis and degradation.

As the monomers and crosslinker molecules degrade through the alkaline hydrolysis reaction, more carboxylic/carboxylate and hydroxyl end groups will be introduced into the gel matrix, which will alter the chemical and the physical nature of the gel, such as swelling and permeability. This will eventually affects the chromatographic performance of the membrane, and change binding capacity, permeability, and product purity between cycles.

To ensure membrane caustic stability, all monomers and crosslinker must be replaced with alternatives that are chemically stable when exposed to basic solutions. Acrylate and methacrylate ingredients instability in basic solutions is attributed to their ester linkage, which is susceptible hydrolysis in caustic conditions, and by replacing the ester linkage with the more stable and caustic resistant acrylamide linkage, such as N,N′-methylenebis(acrylamide) (Bis), more resilient membrane can be made and the membrane stability in caustic solutions can be enhanced remarkably.

### Experimental Section

Chemicals (Aldrich):

2-Hydroxyethylmethacrylate (HEMA), 2-Carboxyethylacrylate (CEA), Trimethylolpropane triacrylate (TRIM-A), 2-Acrylamidoglycolic acid monohydrate (AAGA), acrylic acid (AA), N-(isobutoxymethyl)acrylamide (NIBoMAA), N-(Hydroxyethyl)acrylamide solution (97%) (NHEAA), N,N-Dimethylacrylamide (NNDMAA), N-(3-Methoxypropyl)acrylamide (NMoPAA), N-Isopropylacrylamide (NIPAA or NIPAM), N,N′-Methylenebis(acrylamide) (Bis), 1,3,5-triacryloylhexahydro-1,3,5-triazine (TACHTA), N,N′-dimethylacetamide (DMAc), di(propylene glycol) dimethyl ether, mixture of isomers (DPM), Di(propylene glycol)methyl ether acetate (DPMA), Di(propylene glycol) methyl ether (97%) (DPGME), 4-(2-Hydroxyethoxy)phenyl-(2-hydroxy-2-propyl)ketone (IRGACURE 2959), sodium acetate trihydrate, acetic acid (glacial).

Proteins:

Polyclonal Immuno γ-Globulin IgG (Equitech Inc.).

Making the Membrane:

The monomers and crosslinker(s) are added to specific solvent mixture as well as the Irgacure initiator, and the mixture is stirred long enough to ensure all ingredients have properly dissolved in the solution system. A 7″×7″ support substrate sheet (polypropylene) is placed on polyethylene sheet, then 15 g of the polymer solution is introduced to the substrate sheet, and the impregnated substrate is subsequently covered with another polyethylene sheet. The sheet is pressed gently in circular motion with hand in order to remove excess solution and any entrapped air bubbles. Polymerization process is initiated by applying UV irradiation (˜350 nm) to the sheets sandwich in a closed chamber for 10 min. The resultant membrane is then removed from the polyethylene sheets cover and become a subject for extensive wash cycles using R.O. water, followed by soaking period in sodium hydroxide solution (0.25 M NaOH-30 min), and is finally washed with R.O. water (2-3 times) with agitation. The clean membranes are dried, either by being replaced in oven (50° C.) for 30 minutes, or by hanging freely in the air at room temperature for ˜16 hours.

Binding Capacity Measurement:
a) IgG binding: 25 mm membrane disc was placed in 25 mm Natrix-SS holder and 20 mL of binding buffer (85 mM sod. citrate, pH 5.0) was passed through to achieve equilibration. Then protein solution of 0.5 mg/mL polyclonal IgG (Equitech Inc.) in binding buffer was passed through until the UV absorbance of the effluent exceeded 10% of the feeding solution, and then 10-15 mL of buffer was passed through the cell to wash unbound protein. In elution step, the bound IgG was eluted by passing 10-14 mL of elution buffer (85 mM sodium acetate, 1 M NaCl, pH 5.0).
b) Multicycle IgG binding: the experiment was carried out using Akta Explorer 100 instrument (GE). 25 mm membrane disc was placed in 25 mm Natrix-SS holder and connected to the instrument. 5 ml of sodium hydroxide solution (0.5 mL) was passed through the membrane at 1 mL/min flow rate. Then 20 ml of binding buffer (85 mM sod. citrate, pH 5.0) was passed through to achieve equilibration. Afterward, protein solution (26-30 mL) of 0.5 mg/mL polyclonal IgG (Equitech Inc.) in binding buffer was passed through so the UV absorbance of the effluent exceed 10% of the feeding solution, and then 14 mL of buffer was passed through the cell to wash unbound protein. In elution step, the bound IgG was eluted by passing 10-14 mL of elution buffer (85 mM sod. acetate, 1 M NaCl, pH 5.0). The pass through, wash, and elution fractions were collected and UV absorbance (at 280 nm) were measured to determine the amount of protein that was captured and eluted so that recovery % can be estimated.

Typical C Membrane Formula with Acrylate Crosslinker

The typical C membrane formula is composed of 2.07 g (13.8 wt %) of 2-Carboxyethylacrylate (CEA), 0.245 g (1.63 wt %) of 2-Hydroxyethylmethacrylate (HEMA), 0.536 g (3.57 wt %) of trimethylolpropane triacrylate (TRIM-A), 0.047 g (0.31 wt %) irgacure initiator, 3.6 g (24 wt %) N,N′-dimethylacetamide (DMAc), 8.135 g (54.23 wt %) of di(propylene glycol)methyl ether acetate (DPMA), and 0.369 g (2.46 wt %) of D.I. water.

### A. Base Solution Effect on Membrane and Evidence for Hydrolysis

Membrane coupons (77 cm in diameter) of C membrane were soaked in sodium hydroxide solution of 1 M, and 0.1 M concentration for 4 and 24 hours, then flux and in some cases binding capacity were measured (using water and/or buffer solution).

Results suggest, as shown in tables below, that exposure to sodium hydroxide solution reduced the membrane permeability as indicated by flux reduction. The deteriorating effect of the base on membrane was amplified by exposure time and/or base solution concentration. See FIG. 29.

### B. Making Caustic Stable C Membrane

1) Membrane Made with Acrylic Acid, Bis Crosslinker, and One Acrylamide Co-Monomer

This class of membrane formulas are based on acrylic acid monomer (AA) as functional monomer, and one additional acrylamide co-monomer, with N,N′-methylenebis(acrylamide) (Bis) as a crosslinker. Irgacure (2959) was used as photo-initiator to start the polymerization upon UV irradiation.

Formula Group 1-A

This group is based on acrylic acid, as a carboxylic functional monomer, with N-(isobutoxymethyl)acrylamide (NIBoMAA) as a co-monomer, and N,N′-methylenebis(acrylamide) (Bis) as a crosslinker. The solvent system includes N,N′-dimethylacetamide (DMAc), di(propylene glycol)methyl ether acetate (DPMA), di(propylene glycol) dimethyl ether (DPM)), and deionized water (D.I.). Formulas based on this set of chemicals with some ingredients variation are in FIG. 30.

The polymerization mixture of each formula was formulated and mixed well before being used to cast the membrane (as previously described). Initial flux (using acetate buffer as a solute) of each membrane's coupon was measured, then the coupon was soaked in 1 M sodium hydroxide for 24 hours, afterward the membrane was flushed with water then the flux was measured again, and the ratio of flux (before and after) was calculated. Protein binding capacity (using IgG as a protein capture model) was also measured as described above.

Results, as shown in FIG. 31, indicated that despite variation in the formula components, which resulted in different flux and binding capacity, the membrane flux was not significantly changed after being exposed to caustic solution for prolonged period of time, and compared to the original S membrane formula which totally lost its permeability after caustic exposure, the new membrane preserved its original permeability.

See also FIGS. 32 and 33.

Formula Group 1-B

This group is based on acrylic acid, as a carboxylic functional monomer, and N-(3-Methoxypropyl)acrylamide (NMoPAA) as a co-monomer, and N,N′-methylenebis(acrylamide) (Bis) as a crosslinker. The solvent system includes N,N′-dimethylacetamide (DMAc), di(propylene glycol)methyl ether acetate (DPMA), di(propylene glycol) dimethyl ether (DPM), and deionized water (D.I.). Formulas based on this solvent system were formulated according to the FIG. 34 and membranes were casted and polymerized as described previously.

Initial flux of each membrane's coupon (7.7 cm in diameter) was measured using sodium acetate buffer (85 mM, pH 5) as solute. The membrane coupons were subsequently soaked in 1 M sodium hydroxide for 24 hours, afterward the membrane was flushed with R.O. water and the flux was re-measured. Ratio of flux (before and after) was calculated to demonstrate changes in flux. Protein binding capacity was measured as previously outlines.

As shown in FIG. 35, the results showed again that so made membranes, which were made of variable amounts of monomer and crosslinker, demonstrated caustic stability, and despite the diversity of the membrane permeability, as dictated by formula ingredients, each membrane was capable of maintaining its permeability after prolonged and strong base exposure.

See also FIGS. 36 and 37.

Formula Group C

This group is based on acrylic acid, as a carboxylic functional monomer, with N-Isopropylacrylamide (NIPAA), as a co-monomer, and N,N′-methylenebis(acrylamide) (Bis) as a crosslinker. The solvent system includes N,N′-dimethylacetamide (DMAc), di(propylene glycol)methyl ether acetate (DPMA), di(propylene glycol) dimethyl ether (DPM)), and deionized water (D.I.). As in previous systems, the membrane formulas were prepared and mixed well according to FIG. 38 and reaction mixture was used to cast and prepare the membranes as outlined previously.

Initial flux of each membrane's coupon (77 cm in diameter) was measured using acetate buffer (85 mM, pH 5) as solute, and after soaking the membrane coupons in 1 M sodium hydroxide for 24 hours, the coupons were thoroughly flushed with R.O. water and the flux was measured again using the buffer, then the flux ratio (before and after base exposure) was calculated. Similar to the previous systems, protein binding capacity was also measured, following the procedure described earlier.

The results, as shown in FIG. 39, confirmed the caustic stability of the membrane as the permeability of each membrane was not affected by the prolonged exposure to the caustic solution, and regardless of its initial permeability. Despite the diversity of the membrane permeability, which is mainly controlled by the monomer content, crosslinking degree, and solvent system miscibility, each formula resulted in membrane that was capable of maintaining its original permeability after base exposure.

See also FIGS. 40 and 41.

2) Caustic Stable C Membrane Made with Acrylic Acid, Bis Crosslinker, and Two Different Acrylamide Co-Monomers

In this set of examples, two co-monomers were used to formulate the hydrogel, in addition to the acrylic acid which is responsible for hydrogel functionality.

Formula Group 2-A

In this subgroup, acrylic acid was formulated with N-(isobutoxymethyl)acrylamide (NIBoMAA) and N-(hydroxyethyl)acrylamide (NHEAA), which are basically methylacrylamide derivatives, and N,N′-methylenebis(acrylamide) (Bis) was included as a crosslinker. Irgacure (2959) is added to the formula to initiate the polymerization reaction as the UV irradiation is applied on the sample. The solvent system was similar to the one used in the previous examples, as it included N,N′-dimethylacetamide (DMAc), di(propylene glycol)methyl ether acetate (DPMA), di(propylene glycol) dimethyl ether (DPM), and deionized water (D.I.). The composition of the each gel formula is shown in FIG. 42.

Both the binding capacity of each membrane and the initial flux (using acetate buffer) was determined before the membrane was subject to static soak in 1 M sodium hydroxide solution for 24 hours, after which it was removed, flushed with water then the flux was re-examined, and the ratio (after/before) was calculated.

As shown in FIG. 43, all the formulas demonstrated stability as their permeability are not affected with exposure to the highly caustic solution for prolonged time. These examples showed again that it is possible to make a caustic stable gel and membrane as long as acrylamide crosslinker and monomers were used in the formula.

See also FIGS. 44 and 45.

Formula Group 2-B

In this set of examples, acrylic acid and N-(isobutoxymethyl)acrylamide (NIBoMAA) were formulated with N,N-Dimethylacrylamide (NNDMAA) and N,N′-methylenebis(acrylamide) (Bis) was included as a crosslinker. Irgacure (2959) is added to the formula to initiate the polymerization reaction as the UV irradiation is applied. The solvent system included N,N′-dimethylacetamide (DMAc), di(propylene glycol)methyl ether acetate (DPMA), di(propylene glycol) dimethyl ether (DPM), and deionized water (D.I.). FIG. 46 shows the composition of the each gel formula in this set.

Similar to previous membrane samples, both the binding capacity of each membrane and the buffer flux were determined for each membrane, as well as the buffer flux after the membrane was subjected to caustic exposure through a 24 h soak in 1 M sodium hydroxide solution, and the ratio (after/before) was calculated.

Results, as shown in FIG. 47, showed again that the all formulas demonstrated stability as their permeability are not affected by the prolonged exposure to the caustic solution. These examples demonstrated that it is possible to make a caustic stable gel and membrane as long as acrylamide crosslinker and monomers were used in the formula, and no ester linkage acrylate monomers were included.

See also FIGS. 48 and 49.

Formula Group 2-C

In this set of examples, acrylic acid was formulated with N-Isopropylacrylamide (NIPAA) with N-(hydroxyethyl)acrylamide (NHEAA), and N,N′-methylenebis(acrylamide) (Bis) was included as a crosslinker. Irgacure (2959) is added to the formula to initiate the polymerization reaction as the UV irradiation is applied on the sample. The solvent system was similar to the one used in the previous examples, as it included N,N′-dimethylacetamide (DMAc), di(propylene glycol)methyl ether acetate (DPMA), di(propylene glycol) dimethyl ether (DPM), and deionized water (D.I.). The composition of the each gel formula is shown in FIG. 50.

As shown in FIG. 51, all the formulas demonstrated stability as their permeability are not affected with exposure to the highly caustic solution for prolonged time.

See also FIGS. 52 and 53.

3) Caustic Stable C Membrane Made with Additional Acrylamide Crosslinkers

In this set of examples, the cyclic crosslinker 1,3,5-triacryloylhexahydro-1,3,5-triazine (TACHTA), and N,N′-methylenebis(acrylamide) (Bis) crosslinkers were used jointly in the gel formula to make caustic stable C membrane.

The membrane gel formulas are based on acrylic acid, as a functional monomer, and N,N′-methylenebis(acrylamide) (Bis) and 1,3,5-triacryloylhexahydro-1,3,5-triazine (TACHTA) as crosslinkers. The formulas also included N-(isobutoxymethyl)acrylamide (NIBoMAA) and N,N-Dimethylacrylamide (NNDMAA) as co-monomers. Irgacure (2959) is added to the formula as a photoinitiator. The solvent system was similar to the one used in the previous examples, as it included N,N′-dimethylacetamide (DMAc), di(propylene glycol)methyl ether acetate (DPMA), di(propylene glycol) dimethyl ether (DPM), and deionized water (D.I.). The composition of the each gel formula is shown in FIG. 54.

As previously done with other examples, the binding capacity of these membranes (using IgG) was determined. In addition, each membranes initial flux was determined using coupons of 7.7 cm diameter and sodium acetate buffer (85 mM, pH 5) as a solute, then the membranes coupons were soaked in 1 M sodium hydroxide solution for 24 hours, after which they were removed, flushed with water, then the flux of each membrane was re-examined using the buffer, and the ratio (after/before) was calculated.

Results, as shown in FIG. 55, demonstrated that the membranes made with TACHTA, as an additional crosslinker, were capable of preserving their permeability after the prolonged exposure to the caustic solution. It is evident that the use of acrylamide crosslinkers resulted in robust and caustic stable membrane.

See also FIGS. 56 and 57.

4) Caustic Stable C Membrane Made with Carboxylic Acrylamide Monomer

In this example, the membrane was made using acrylic acid and 2-Acrylamidoglycolic acid, as carboxylic functional monomers, with N,N-Dimethylacrylamide (NNDMAA) as a co-monomer and N,N′-methylenebis(acrylamide) (Bis) as a crosslinker. The solvent system in this example include N,N′-dimethylacetamide (DMAc), di(propylene glycol)methyl ether acetate (DPMA), di(propylene glycol) methyl ether (DPGME), and deionized water (D.I.), according to FIG. 58.

Examining the membrane binding capacity and flux change before and after caustic exposure showed that the membrane possesses caustic stability, and it is possible to make stable membrane provided that the ingredients used in the formula are stable when exposed to basic solution. See FIG. 59.

5) Caustic Stable C Membrane Made with Different Solvent System

In this set of examples, the membranes were made using acrylic acid, as a carboxylic functional monomer, and N-(3-Methoxypropyl)acrylamide (NMoPAA), as a co-monomer and N,N′-methylenebis(acrylamide) (Bis) as a crosslinker. The solvent system in these examples include N,N′-dimethylacetamide (DMAc), di(propylene glycol) dimethyl ether (DPM)), and deionized water (D.I.). See FIG. 60.

Examining the resultant membranes showed once again that each membrane was not affected by the exposure to the caustic solution for prolonged time, and that the use of different solvent system and the variation in the formula may change the membrane performance, in terms of permeability and capacity, but will not affect its caustic stability, which is solely affected by the chemical nature of monomers used to build the gel, and not the solvent system. See FIG. 61.

### 6) Caustic Stable C Membrane Multicycle Performance

To demonstrate the caustic stability of C membrane that is made of acrylamide monomers and crosslinkers, two membranes were subjects for multicycle run experiment that included an exposure step whereas basic solution (0.5 M NaOH) was passed through the membrane at the beginning of every single bind/elute cycle, for a total of 45 cycles in continuous run. One membrane formula (1-B6) is based on acrylic acid, as a carboxylic functional monomer, with N-(3-Methoxypropyl)acrylamide (NMoPAA) and N,N′-methylenebis(acrylamide) as co-monomer and crosslinker, respectively. Another membrane formula (2-A4) is based on acrylic acid, with N-(isobutoxymethyl)acrylamide (NIBoMAA) and N-(hydroxyethyl)acrylamide (NHEAA) as co-monomers, and N,N′-methylenebis(acrylamide) as a crosslinker.

As shown in FIGS. 62 and 63, both membrane have shown robust performance and consistency along the 45 cycles of run as both binding capacity and recovery (>95) remained unchanged, despite the exposure to the strong basic solution of sodium hydroxide (0.5 M) in every cycle, and up to 45 consecutive cycles.

### Discussion

The gel part of the cation exchange membrane C contains carboxylic groups that can be ionised into carboxylate groups, and those are responsible for the binding capability of the membrane as they provide negative charges that take part in the ionic interaction between the targeted biomolecules and the surface.

At certain solution pH and conductivity, there is a part of the carboxylic groups in the acid form while the rest are in the ionized form. In their charged status, the hydrophilic carboxylate groups can attract water molecules around them and this will contribute greatly to the membrane gel swelling. Therefore, it is expected that when the membrane is exposed to high pH solution, the permeability will drop. However, it is possible to reverse this action by shifting the solution pH to a lower value, or by increasing the ionic content of the solution (e.g., adding salt), which will mask the charge and minimize the swelling. This explains why flux is usually higher when passing acetate buffer solution of pH 5 through the membrane, compared to pure water. This reversible effect can only work if the membrane integrity and structure were preserved and chemical degradation did not take place.

A typical C membrane is made of 2-Carboxyethylacrylate (CEA) and 2-Hydroxyethylmethacrylate (HEMA) monomers, and trimethylolpropane triacrylate (TRIM-A) as crosslinker. When this membrane was soaked in 1 M sodium hydroxide solution for 24 hours, the membrane permeability was completely lost as the water and buffer flux through the membrane dropped to zero. Even with lower concentration of base solution (such as 0.1 M NaOH), the membrane could only tolerate a limited time exposure and not an extended one.

As shown by previous studies on molecular level, acrylate monomer hydrolysis takes place in basic solution. It is conceivable that when the membrane is exposed to the basic condition, ester linkage undergoes hydrolysis, and carboxylate and hydroxyl groups are generated, which in turn alter the gel chemical and physical properties.

As gel membranes are exposed to alkaline solution, the ester bonds become hydrolyzed and generation of carboxylate groups as well as hydroxyl groups takes place. As the newly generated carboxylate groups bring more negative charge to the gel media and swelling, the process affects not only the structure of the gel, but also its integrity as crosslinking degree is reduced by the alkaline hydrolysis of the crosslinker.

Following the same approach that is proven to work in the case of S membrane, the gel caustic stability can be enhanced by replacing the base sensitive ingredients of the gel with more base resistant ingredients that do not possess hydrolysable bonds like the ester bonds, and can withstand harsh and prolonged exposure to basic solutions. As amide bond is known to be less susceptible to hydrolysis than ester bond under basic conditions, acrylamide monomers and crosslinkers were used to formulate the newly caustic stable C membranes.

In the first set of examples, the membrane gel polymers were made using acrylic acid, which cannot be degraded by basic solutions, and different acrylamide monomers, such as N-(isobutoxymethyl)acrylamide (NIBoMAA), N-(3-Methoxypropyl)acrylamide (NMoPAA), and N-Isopropylacrylamide (NIPAA), with N,N′-methylenebis(acrylamide) (Bis) as a crosslinker.

Despite the variation of the formulas, and the different hydrophilic properties of the monomers due to their structure, it was possible to formulate these ingredients to make a membrane gel that is capable to operate efficiently and withstand harsh exposure to basic solutions (1 M NaOH for 24 h).

Moreover, in the second set of examples, two or more of acrylamide co-monomers were successfully incorporated in formulas that provides range of permeability and binding capacity, and all resulted gel membrane proven to be robust, when their stability was examined under prolonged exposure to caustic solutions.

Other examples also showed that it is possible to include additional crosslinkers, as well as other carboxylic acrylamide monomer to the formula, and the resultant membrane is still capable of withstanding a strong exposure to basic solutions. It is even possible to move into a new solvent system and this will not affect the membrane caustic stability.

To further demonstrate the caustic stability during harsh operational conditions, the chromatographic performance of two membranes of different ingredients was examined throughout an extended multicycle run. Each membrane was used in multicycle run (45 cycles of bind/elute) that included a caustic exposure (using 0.5 M NaOH) step in the beginning of every cycle of that run. Results have shown clearly that both membranes delivered a very consistent performance with clear resistance to caustic deteriorating effect. So it is evident that these membranes can survive and operate successfully through any bio-separation process that requires a caustic sanitization step.

Replacing monomers and crosslinkers that possess ester linkage in the gel part of the membrane with alternative monomers and crosslinker that have amide linkage rendered the membranes caustic stable because the replacement increased (i) the stability of the underlying chemical structure, and (ii) the consistency of performance under caustic conditions.

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

I claim:

1. A composite material, comprising:
a support member, comprising a plurality of pores extending through the support member; and
a cross-linked gel, wherein the cross-linked gel comprises a polymer derived from a monomer and a cross-linker; the monomer does not comprise ester functionality; and the cross-linker does not comprise ester functionality;
wherein the cross-linked gel is located in the pores of the support member.

2. The composite material of claim 1, wherein the cross-linked gel is macroporous.

3. The composite material of claim 1, wherein the monomer is acrylic acid, acrylamide, N-acryloxysuccinimide, N,N-diethylacrylamide, N,N-dimethylacrylamide, N-[3-(N,N-dimethylamino)propyl]methacrylamide, N,N-dimethylacrylamide, methacrylamide, N-isopropylacrylamide, styrene, 4-vinylpyridine, vinylsulfonic acid, N-vinyl-2-pyrrolidinone (VP), acrylamido-2-methyl-1-propane sulfonic acid, N-(hydroxymethyl)acrylamide, N-(isobutoxymethyl)acrylamide, N-(hydroxyethyl)acrylamide, N-(3-Methoxypropyl)acrylamide, 2-acrylamidoglycolic acid, N-vinylformamide, N-[tris(hydroxymethyl)methyl]acrylamide, 3-acryloylamino-1-propanol, styrene sulfonic acid, (3-acrylamidopropyl)trimethylammonium halide, diallyldimethylammonium halide, 4-vinyl-N-methylpyridinium halide, vinylbenzyl-N-trimethylammonium halide, omethacryloxyethyltrimethylammonium halide, N-acrylamido polyethylenimine, N-methacrylamido polyethylenimine, N-acrylamido 4-arm amine-terminated poly(ethylene oxide), N-methacrylamido 4-arm amine-terminated poly(ethylene oxide), N-acrylamido trimethylolpropane tris[poly(propylene glycol)amine-terminated]ether, N-methacrylamido trimethylolpropane tris[poly(propylene glycol)amine-terminated]ether, N-acrylamido amine-terminate poly(N-isopropylacrylamide), N-methacrylamido amine-terminate poly(N-isopropylacrylamide), N-acrylamido poly-L-arginine hydrochloride, N-methacrylamido poly-L-arginine hydrochloride, N-acrylamido poly(ethylene glycol) bis(amine), N-methacrylamido poly(ethylene glycol) bis(amine), N-acrylamido poly(allylamine hydrochloride), N-methacrylamido poly(allylamine hydrochloride), N-acrylamido poly(dimethylamine-co-epichlorohydrin-co-ethylenediamine), N-methacrylamido poly(dimethylamine-co-epichlorohydrin-co-ethylenediamine), or diacetone acrylamide.

4. The composite material of claim 1, wherein the cross-linking agent is selected from the group consisting of bisacrylamidoacetic acid, 2,2-bis[4-(2-acryloxyethoxy)phenyl]propane, 2,2-bis(4-methacryloxyphenyl)propane, 1,4-butanediol divinyl ether, 1,4-diacryloylpiperazine, diallylphthalate, N,N-dodecamethylenebisacrylamide, divinylbenzene, glycerol tris(acryloxypropyl)ether, N,N′-hexamethylenebisacrylamide, triethylene glycol divinyl ether, diallyl diglycol carbonate, poly(ethylene glycol) divinyl ether, N,N′-dimethacryloylpiperazine, divinyl glycol, N,N′-methylenebisacrylamide, N,N′-ethylenebis(acrylamide), N,N′-(1,2-dihydroxyethylene)bis-acrylamide, N,N′-hexamethylenebis(methacrylamide), N,N′-octamethylenebisacrylamide, N,N′-dimethacryloylpiperazine, 1,3,5-triacryloylhexahydro-1,3,5-triazine, and divinylbenzene.

5. The composite material of claim 1, wherein the composite material is a membrane.

6. The composite material of claim 1, wherein the support member has a void volume; and the void volume of the support member is substantially filled with the cross-linked gel.

7. The composite material of claim 1, wherein the thickness of the support member is about 10 μm to about 1000 μm.

8. The composite material of claim 1, wherein the support member comprises a polyolefin.

9. The composite material of claim 1, wherein the support member comprises a polymeric material selected from the group consisting of polysulfones, polyethersulfones, polyphenyleneoxides, polycarbonates, polyesters, cellulose and cellulose derivatives.

10. A method, comprising the step of:
contacting at a first flow rate a first fluid, comprising a substance, with a composite material of claim 1, thereby adsorbing or absorbing a portion of the substance onto the composite material.

11. The method of claim 10, wherein the first fluid further comprises a fragmented antibody, aggregated antibodies, a host cell protein, a polynucleotide, an endotoxin, or a virus.

12. The method of claim 10, further comprising the step of:
contacting at a second flow rate a second fluid with the substance adsorbed or absorbed onto the composite material, thereby releasing a first portion of the substance from the composite material.

13. The method of claim 10, wherein the substance is a biological molecule or biological ion selected from the group consisting of albumins, lysozyme, viruses, cells, γ-globulins of human and animal origins, immunoglobulins of human and animal origins, proteins of recombinant and natural origins, polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, nucleic acid derived products, DNA of synthetic and natural origins, and RNA of synthetic and natural origins.

14. The method of claim 10, wherein the concentration of the substance in the first fluid is about 0.2 mg/mL to about 10 mg/mL.

15. The method of claim 10, further comprising the steps of:
cleaning the composite material; and
repeating the above-mentioned steps.

16. The method of claim 15, wherein the composite material is cleaned with a basic solution.

17. The method of claim 15, wherein the composite material is cleaned with a fourth fluid; and the fourth fluid comprises sodium hydroxide.

18. A method, comprising the step of:
contacting at a first flow rate a first fluid, comprising a substance and an unwanted material, with a composite material of claim 1, thereby adsorbing or absorbing a portion of the unwanted material onto the composite material.

19. The method of claim 18, wherein the unwanted material comprises a fragmented antibody, aggregated antibodies, a host cell protein, a polynucleotide, an endotoxin, or a virus.

20. The method of claim 18, wherein the substance is a biological molecule or biological ion selected from the group consisting of albumins, lysozyme, viruses, cells, γ-globulins of human and animal origins, immunoglobulins of human and animal origins, proteins of recombinant and natural origins, polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, nucleic acid derived products, DNA of synthetic and natural origins, and RNA of synthetic and natural origins.
